(19) United States
(12) Patent Application Publication
(10) Pub. No.: US 2007/0050605 A1
(43) Pub. Date: Mar. 1, 2007

(54) Freeze-dried ghost pages

(76) Inventors: Bran Ferren, Beverly Hills, CA (US); W. Daniel Hillis, Encino, CA (US); William Henry Mangione-Smith, Kirkland, WA (US); Nathan P. Myhrvold, Medina, WA (US); Clarence T. Tegreene, Bellevue, WA (US); Lowell L. Wood JR., Livermore, CA (US)

Correspondence Address: SEARETE LLC;CLARENCE T. TEGREENE, 1756 - 114TH AVE., S.E., SUITE 110, BELLEVUE, WA, 98004, US

(21) Appl. No.: 11/324,174

(22) Filed: Dec. 30, 2005

Related U.S. Application Data
(63) Continuation-in-part of application No. 11/214,449, filed on Aug. 29, 2005.
(63) Continuation-in-part of application No. 11/214,458, filed on Aug. 29, 2005.
(63) Continuation-in-part of application No. 11/214,459, filed on Aug. 29, 2005.
(63) Continuation-in-part of application No. 11/292,207, filed on Nov. 30, 2005.
(63) Continuation-in-part of application No. 11/292,296, filed on Nov. 30, 2005.
(63) Continuation-in-part of application No. 11/291,503, filed on Nov. 30, 2005.
(63) Continuation-in-part of application No. 11/292,323, filed on Nov. 30, 2005.

(51) Int. Cl. G06F 9/44

(52) U.S. Cl. 712/226

(57) ABSTRACT

Embodiments include a device, apparatus, and a method. In an embodiment, an apparatus includes a first processor operable to execute a program. The apparatus also includes an information store configured by an execution-based optimization profile, the execution-based optimization profile usable in an execution of the program and that was created utilizing data collected during a runtime execution of the program by a second processor and transparent to software executing on the second processor. The apparatus further includes an execution-optimization circuit operable to alter an execution of the program by the first processor in response to the execution-based optimization profile.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith.

### RELATED APPLICATIONS

For purposes of the USPTO extra-statutory requirements, the present application constitutes a continuation-in-part of U.S. patent application entitled PROCESSOR RESOURCE MANAGEMENT, naming Bran Ferren; W. Daniel Hillis; Nathan P. Myhrvold; Clarence T. Tegreene; and Lowell L. Wood, Jr. as inventors, U.S. Ser. No. 11/214,449, filed Aug. 29, 2005.

For purposes of the USPTO extra-statutory requirements, the present application constitutes a continuation-in-part of U.S. patent application entitled MULTIPROCESSOR RESOURCE OPTIMIZATION, naming Bran Ferren; W. Daniel Hillis; Nathan P. Myhrvold; Clarence T. Tegreene; and Lowell L. Wood, Jr. as inventors, U.S. Ser. No. 11/214,458, filed Aug. 29, 2005.

For purposes of the USPTO extra-statutory requirements, the present application constitutes a continuation-in-part of U.S. patent application entitled PREDICTIVE PROCESSOR RESOURCE MANAGEMENT, naming Bran Ferren; W. Daniel Hillis; William Henry Mangione-Smith; Nathan P. Myhrvold; Clarence T. Tegreene; and Lowell L. Wood, Jr. as inventors, U.S. Ser. No. 11/214,459, filed Aug. 29, 2005.

For purposes of the USPTO extra-statutory requirements, the present application constitutes a continuation-in-part of U.S. patent application entitled RUNTIME-BASED OPTIMIZATION PROFILE, naming Bran Ferren; W. Daniel Hillis; William Henry Mangione-Smith; Nathan P. Myhrvold; Clarence T. Tegreene; and Lowell L. Wood, Jr. as inventors, U.S. Ser. No. 11/292,207, filed Nov. 30, 2005.

For purposes of the USPTO extra-statutory requirements, the present application constitutes a continuation-in-part of U.S. patent application entitled ALTERATION OF EXECUTION OF A PROGRAM IN RESPONSE TO AN EXECUTION-OPTIMIZATION INFORMATION, naming Bran Ferren; W. Daniel Hillis; William Henry Mangione-Smith; Nathan P. Myhrvold; Clarence T. Tegreene; and Lowell L. Wood, Jr. as inventors, U.S. Ser. No. 11/292,296, filed Nov. 30, 2005.

For purposes of the USPTO extra-statutory requirements, the present application constitutes a continuation-in-part of U.S. patent application entitled FETCH REROUTING IN RESPONSE TO AN EXECUTION-BASED OPTIMIZATION PROFILE, naming Bran Ferren; W. Daniel Hillis; William Henry Mangione-Smith; Nathan P. Myhrvold; Clarence T. Tegreene; and Lowell L. Wood, Jr. as inventors, U.S. Ser. No. 11/291,503, filed Nov. 30, 2005.

For purposes of the USPTO extra-statutory requirements, the present application constitutes a continuation-in-part of U.S. patent application entitled HARDWARE-GENERATED AND HISTORICALLY-BASED EXECUTION OPTIMIZATION, naming Bran Ferren; W. Daniel Hillis; William Henry Mangione-Smith; Nathan P. Myhrvold; Clarence T. Tegreene; and Lowell L. Wood, Jr. as inventors, U.S. Ser. No. 11/292,323, filed Nov. 30, 2005.

The United States Patent Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003 at

http://www.uspto.gov/web/offices/com/sol/og/2003/week11/patbene.htm. The present applicant entity has provided a specific reference to the application(s)from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

### SUMMARY

An embodiment provides an apparatus. The apparatus includes a first processor operable to execute a program. The apparatus also includes an information store configured by an execution-based optimization profile, the execution-based optimization profile usable in an execution of the program and that was created utilizing data collected during a runtime execution of the program by a second processor and transparent to software executing on the second processor. The apparatus further includes an execution-optimization circuit operable to alter an execution of the program by the first processor in response to the execution-based optimization profile. In addition to the foregoing, other apparatus embodiments are described in the claims, drawings, and text form a part of the present application.

Another embodiment provides a device. The device includes means for executing a computer program. The device also includes means for configuring a computer storage medium in response to an execution-based optimization profile. The execution-optimization information is usable in an execution of a program and was generated utilizing data collected by a hardware device and corresponding to a runtime execution of the program by a second processor. The device further includes means for altering the execution of the computer program in response to the execution-based optimization profile. The device may include means for receiving the execution-based optimization profile and altering the execution of the computer program in response to the execution-based optimization profile. In addition to the foregoing, other device embodiments are described in the claims, drawings, and text form a part of the present application.

A further embodiment provides a method. The method includes configuring a computer storage medium in response to an execution-optimization information. The execution-optimization information is usable in an execution of a program and was generated utilizing data collected by a hardware device and corresponding to a runtime execution of the program by a second processor. The method also includes modifying an execution of the program by a first processor in response to the execution-optimization information. The method may further include receiving the execution-optimization information. In addition to the foregoing, other method embodiments are described in the claims, drawings, and text form a part of the present application.

An embodiment provides an apparatus. The apparatus includes an execution-based optimization profile usable during an execution of a computer program by a first processor and derived by a hardware device utilizing data generated during a runtime execution of the computer program by a second processor. The apparatus also includes a computer-readable medium encoded with the execution-based optimization profile. In addition to the foregoing, other method embodiments are described in the claims, drawings, and text form a part of the present application.

The foregoing is a summary and thus by necessity contains simplifications, generalizations and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein.

### BRIEF DESCRIPTION OF THE DRAWINGS

In the following detailed description of exemplary embodiments, reference is made to the accompanying drawings, which form a part hereof. In the several figures, like referenced numerals identify like elements. The detailed description and the drawings illustrate exemplary embodiments. Other embodiments may be utilized, and other changes may be made, without departing from the spirit or scope of the subject matter presented here. The following detailed description is therefore not to be taken in a limiting sense, and the scope of the claimed subject matter is defined by the appended claims.

FIG. 1 illustrates a partial view of an exemplary device in which embodiments may be implemented;

FIG. 2 illustrates a partial view of an exemplary device in which embodiments may be implemented;

FIG. 3 partially illustrates an association between optimization information and a program and/or data;

FIG. 4 illustrates an exemplary operational flow in which embodiments may be implemented;

FIG. 5 illustrates an alternative embodiment of the exemplary operational flow of FIG. 4;

FIG. 6 illustrates another alternative embodiment of the exemplary operational flow of FIG. 4;

FIG. 7 illustrates a partial view of an exemplary device in which embodiments may be implemented;

FIG. 8 illustrates a partial view of an exemplary device in which embodiments may be implemented;

FIG. 9 illustrates an exemplary operational flow implemented in a hardware device and in which embodiments may be implemented;

FIG. 10 illustrates an alternative embodiment of the exemplary operational flow of FIG. 9;

FIG. 11 illustrates another alternative embodiment of the exemplary operational flow of FIG. 9;

FIG. 12 illustrates a further alternative embodiment of the exemplary operational flow of FIGS. 9 and 11;

FIG. 13 illustrates an alternative embodiment of the exemplary operational flow of FIGS. 9 and 11;

FIG. 14 illustrates another alternative embodiment of the exemplary operational flow of FIGS. 9 and 11;

FIG. 15 illustrates another alternative embodiment of the exemplary operational flow of FIG. 9;

FIG. 16 illustrates a partial view of an exemplary device in which embodiments may be implemented;

FIG. 17 illustrates a partial view of an exemplary device in which embodiments may be implemented;

FIG. 18 illustrates an exemplary operational flow that may implement embodiments;

FIG. 19 illustrates an alternative embodiment of the exemplary operational flow of FIG. 18;

FIG. 20 illustrates an alternative embodiment of the exemplary operational flow of FIG. 18;

FIG. 21 illustrates an alternative embodiment of the exemplary operational flow of FIG. 18;

FIG. 22 illustrates a partial view of an exemplary device in which embodiments may be implemented;

FIG. 23 illustrates a partial view of an exemplary device in which embodiments may be implemented;

FIG. 24 illustrates an exemplary operational flow in which embodiments may be implemented;

FIG. 25 illustrates an alternative embodiment of the exemplary operational flow of FIG. 24;

FIG. 26 illustrates another alternative embodiment of the exemplary operational flow of FIG. 24;

FIG. 27 illustrates a further alternative embodiment of the exemplary operational flow of FIG. 24;

FIG. 28 illustrates an alternative embodiment of the exemplary operational flow of FIG. 24, and includes FIGS. 28A and 28B;

FIG. 29 illustrates a device in which embodiments may be implemented;

FIG. 30 illustrates a partial view of an exemplary apparatus in which embodiments may be implemented;

FIG. 31 partially illustrates an embodiment of an information store hierarchy of computer-readable media;

FIG. 32 illustrates a partial view of an embodiment of a device in which embodiments may be implemented;

FIG. 33 illustrates an exemplary operational flow;

FIG. 34 illustrates an alterative embodiment of the exemplary operational flow of FIG. 33;

FIG. 35 illustrates another embodiment of the exemplary operational flow of FIG. 33;

FIG. 36 illustrates a further embodiment of the exemplary operational flow of FIG. 33;

FIG. 37 illustrates another embodiment of the exemplary operational flow of FIG. 33;

FIG. 38 illustrates a further embodiment of the exemplary operational flow of FIG. 33;

FIG. 39 illustrates another embodiment of the exemplary operational flow of FIG. 33; and

FIG. 40 illustrates an exemplary apparatus in which embodiments may be implemented.

### DETAILED DESCRIPTION

In the following detailed description of exemplary embodiments, reference is made to the accompanying drawings, which form a part hereof. In the several figures, like referenced numerals identify like elements. The detailed description and the drawings illustrate exemplary embodiments. Other embodiments may be utilized, and other changes may be made, without departing from the spirit or scope of the subject matter presented here. The following detailed description is therefore not to be taken in a limiting sense, and the scope of the claimed subject matter is defined by the appended claims.

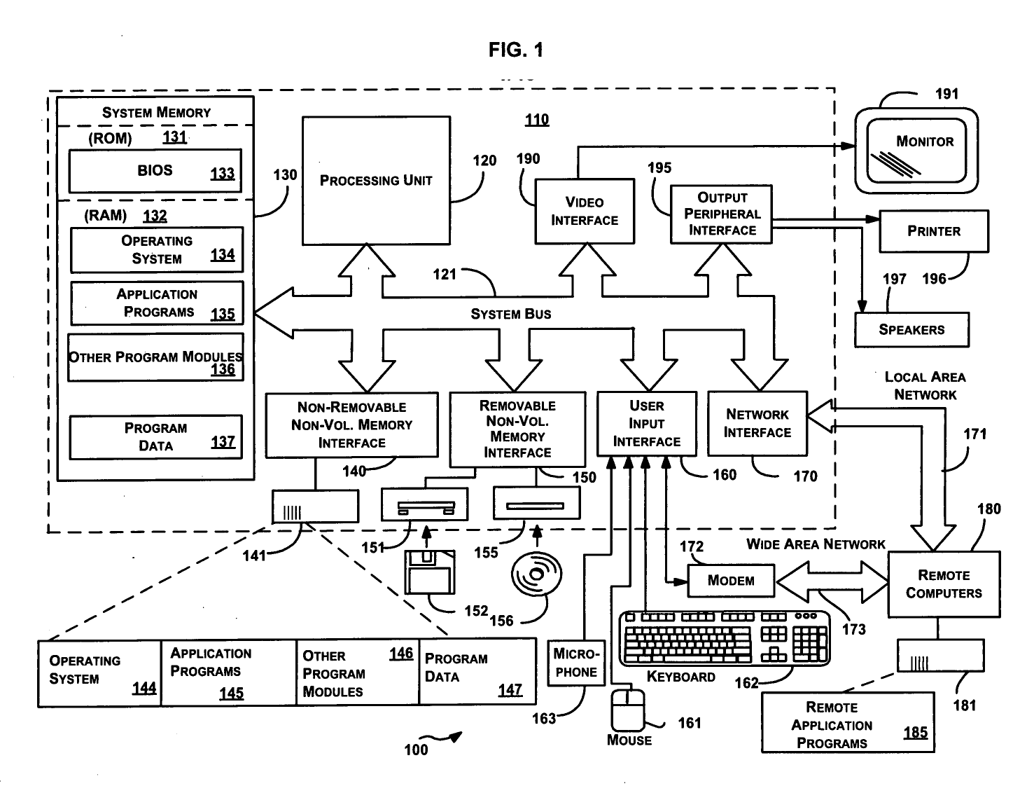

FIG. 1 illustrates an exemplary general-purpose computing system in which embodiments may be implemented, shown as a computing system environment 100. Components of the computing system environment 100 may include, but are not limited to, a computing device 110 having a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media and communications media. Computer storage media includes volatile and nonvolatile, removable and non-removable media implemented in any method or technology for storage of information such as computer-readable instructions, data structures, program modules, or other data. Computer storage media include, but are not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media. Combinations of any of the above should also be included within the scope of computer-readable media.

The system memory 130 includes computer storage media in the form of volatile and nonvolatile memory such as ROM 131 and RAM 132. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by processing unit 120. By way of example, and not limitation, FIG. 1 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art. In an embodiment, an information store may include a computer storage media.

The computing device 110 may also include other removable/non-removable, volatile/nonvolatile computer storage media products. By way of example only, FIG. 1 illustrates a non-removable non-volatile memory interface (hard disk interface) 140 that reads from and writes to non-removable, non-volatile magnetic media, a magnetic disk drive 151 that reads from and writes to a removable, non-volatile magnetic disk 152, and an optical disk drive 155 that reads from and writes to a removable, non-volatile optical disk 156 such as a CD ROM. Other removable/nonremovable, volatile/non-volatile computer storage media that can be used in the exemplary operating environment include, but are not limited to, magnetic tape cassettes, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 1 provide storage of computer-readable instructions, data structures, program modules, and other data for the computing device 110. In FIG. 1, for example, hard disk drive 141, is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies. A user may enter commands and information into the computing device 110 through input devices such as a microphone 163, keyboard 162, and pointing device 161, commonly referred to as a mouse, trackball, or touch pad. Other input devices (not shown) may include a joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 1. The logical connections depicted in FIG. 1 include a local area network (LAN) 171 and a wide area network (WAN) 173, but may also include other networks such as a personal area network (PAN) (not shown). Such networking environments are commonplace in offices, enterprise-wide computer networks, intranets, and the Internet.

When used in a LAN networking environment, the computing system environment 100 is connected to the LAN 171 through a network interface or adapter 170. When used in a WAN networking environment, the computing device 110 typically includes a modem 172 or other means for establishing communications over the WAN 173, such as the Internet. The modem 172, which may be internal or external, may be connected to the system bus 121 via the user input interface 160, or via another appropriate mechanism. In a networked environment, program modules depicted relative to the computing device 110, or portions thereof, may be stored in a remote memory storage device. By way of example, and not limitation, FIG. 1 illustrates remote application programs 185 as residing on computer storage medium 181. It will be appreciated that the network connections shown are exemplary and other means of establishing a communications link between the computers may be used.

FIG. 1 is intended to provide a brief, general description of an illustrative and/or suitable exemplary environment in which embodiments may be implemented. An exemplary system may include the computing system environment 100 of FIG. 1. FIG. 1 is an example of a suitable environment and is not intended to suggest any limitation as to the structure, scope of use, or functionality of an embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing device 110 of FIG. 1. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

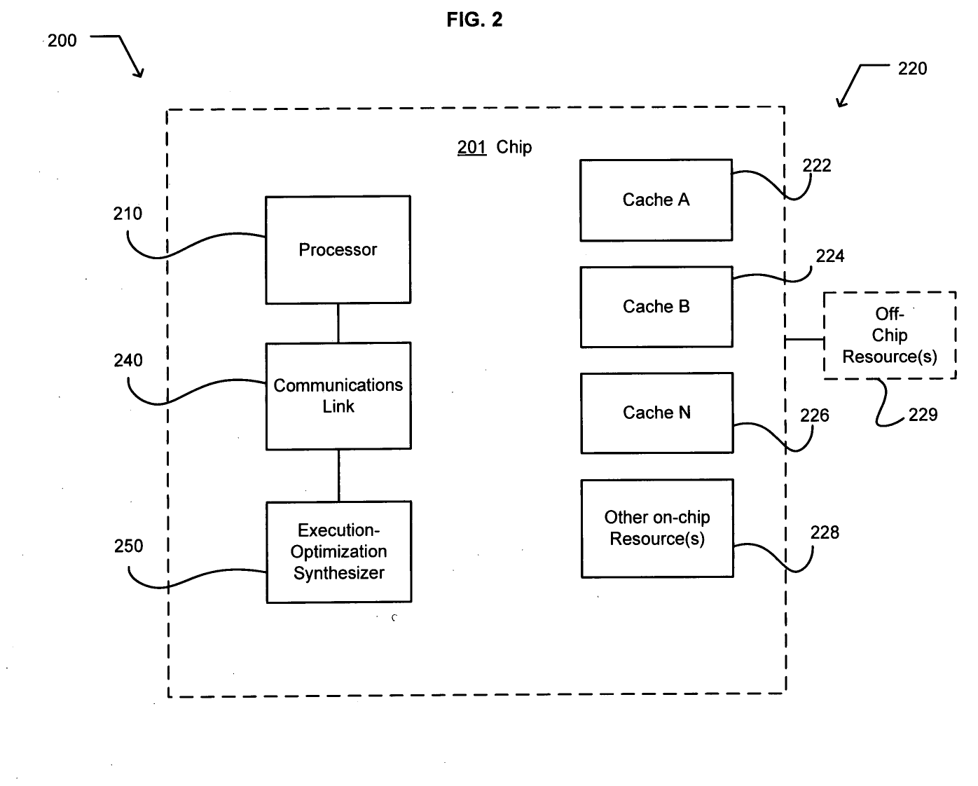

FIG. 2 illustrates a partial view of an exemplary device 200 in which embodiments may be implemented. The device includes a processor 210, an execution-optimization synthesizer 250, and a communications link 240 exposed to the execution-optimization synthesizer and to the processor. The processor may include any processing unit, and may be described as a central processing unit that controls operation of a computer, such as for example, the processing unit 120 described in conjunction with FIG. 1. The device may also include a hardware resource 220 interconnected with the processor. The hardware resource may be any hardware resource associated and/or interconnected with the processor. In an embodiment, the hardware resource may include one or more caches, illustrated as a cache A (222), a cache B (224), and through a cache N (226). Also, the hardware resource may include a branch predictor (not shown). In another embodiment, the hardware resource 220 may include any other resource associated with the processor, illustrated as other on-chip resource 228. In a further embodiment, the hardware resource includes an off-chip resource, illustrated as an off-chip resource 229. For example, the cache A (222) may be an on-chip L1 cache and the off-chip resource 229 may be an off-chip cache, such as an off-chip L2 cache.

The processor 210 includes a processor operable to execute an instruction set. In an embodiment, the instruction set may include a collection of instructions that the processor can execute. In a further embodiment, the instruction set may include an instruction set architecture of the processor. In another embodiment, the instruction set may include a group of machine instructions and/or computer instructions that the processor can execute. In another embodiment, the instruction set may be interpreted by the processor. In further embodiment, the instruction set may include a high-level language, an assembly language, and/or a machine code that the processor can execute, with or without a compiling and/or a translation. In an embodiment, an instruction of the instruction set may include a functional instruction, a branching instruction, a memory instruction, and/or other instruction that may be executed by a processor. In another embodiment, an instruction of the instruction set may include a statement or a portion of a statement in a program. In a further embodiment, an instruction group includes at least two statements from a program. A program may include any type of a program, from several lines of instructions, to an application, and to an operating system. In an embodiment, an instruction of the instruction set may include a decoded instruction, a translated instruction, a portion of a translated instruction, and/or a micro-operation. In a further embodiment, an instruction of the instruction set may include an instruction block, a basic block, a functional block, and/or an instruction module of the instruction set.

The execution-optimization synthesizer 250 includes an execution-optimization synthesizer operable to collect data from the communications link that corresponds to an execution of at least one instruction of the instruction set. In an embodiment, the data may include certain data items, such as datum, byte, bit, and/or a block that are associated together. The execution-optimization synthesizer is also operable to generate an execution-optimization information utilizing the collected data from the communications link and corresponding to the execution of at least one instruction of the instruction set.

In an embodiment, the communications link 240 may include at least one of a signal-bearing medium, digital-signal-bearing medium, a light propagation medium, a light propagation medium, an optical fiber, a light guide, a computer readable storage medium, a hardware register, a bus, a memory local to the processor, an interconnection structure, and/or a digital-signal conductor. For example, a computer readable storage medium may include a memory and/or a memory system directly accessible by the processor and the execution-optimization synthesizer. By way of further example, a digital-signal conductor may include any digital signal conducting structure configured to at least transfer digital signals from the processor to the execution-optimization synthesizer. In another embodiment, the communications link includes a signal-bearing medium exposed only to an execution-optimization synthesizer and the processor. In a further embodiment, the communications link includes a signal-bearing medium exposed to an execution-optimization synthesizer and the processor, and transparent to software executing on the processor. In another embodiment, the communications link includes a signal-bearing medium exposed to an execution-optimization synthesizers to the processor, and to software.

In an embodiment, the processor 210 and the communications link 240 reside on a single chip, illustrated as a single chip 201. In another embodiment, the processor and the execution-optimization synthesizer 250 reside on a single chip, also illustrated as the single chip 201. In a further embodiment, the processor, communications link, and the execution-optimization synthesizer are formed on a single chip, illustrated as the single chip 201.

In an embodiment, the execution-optimization synthesizer 250 includes a hardware implemented execution-optimization synthesizer. In another embodiment, the execution-optimization synthesizer includes a microengine implemented execution-optimization synthesizer.

In a further embodiment, the execution-optimization synthesizer 250 operable to collect data from the communications link that corresponds to an execution of at least one instruction of the instruction set includes an execution-optimization synthesizer operable to collect dynamic data from the communications link that corresponds to a runtime execution of at least one instruction of the instruction set. In an embodiment, the data collected by the execution-optimization synthesizer includes at least one of an interpreted instruction of the instruction set, a translated instruction of the instruction set, a decoded instruction of the instruction set, a micro-operation corresponding to at least a portion of the at least one instruction of the instruction set, data correlating to the execution of the at least one instruction of the instruction set, a movement of data correlating to an execution of the at least one instruction of the instruction set, a result of an execution of the at least one instruction of the instruction set, a branch outcome of an execution of the at least one instruction of the instruction set, an exception correlating to an execution of the at least one instruction of the instruction set, a store-to-load dependency correlating an execution of the at least one instruction of the instruction set, a predicted value correlating to an execution of the at least one instruction of the instruction set, and/or a relationship between at least two instructions of the instruction set.

In an embodiment, the execution-optimization synthesizer 250 operable to collect data from the communications link that corresponds to an execution of at least one instruction of the instruction set includes an execution-optimization synthesizer operable to collect at least one of data transparent to a user, data visible to a user, data transparent to software executing on the processor, data visible to software executing on the processor, and/or data exposed for user manipulation.

In another embodiment, the execution-optimization synthesizer 250 operable to generate an execution-optimization information utilizing the collected data includes an execution-optimization synthesizer operable to generate an optimization information that is at least one of responsive to the collected data, derived from the collected data, associated with the collected data, and/or using the collected data. In a further embodiment, the execution-optimization synthesizer operable to generate an execution-optimization information corresponding to the execution of at least one instruction of the instruction set includes an execution-optimization synthesizer operable to generate at least one of an execution-environment optimization information, a processor-environment optimization information, a data-environment optimization information, and/or a metadata reporting an execution environment. For example, an execution-environment optimization information may include an indication that an identified micro-op is used frequently and may be advantageously saved in a memory close to the processor 210. Another execution-environment optimization may include one or more versions of the at least one instruction of the instruction set that provides some expected benefit over the original at least one instruction of the instruction set. A memory management system serving the processor may cause one of the versions to be executed transparently instead of the original at least one instruction of the instruction set, such as through a translation lookaside buffer. By way of further example, metadata reporting an execution environment may include tracking information with respect to data objects. For example, certain access predictors may work well with certain data objects, or some objects do not appear to be co-resident in the cache, or may be highly co-resident, or certain pointers in object-orientated systems typically point to specific object types, or specific value predictors have worked well with some data in the past.

In other embodiments, the execution-optimization synthesizer 250 operable to generate an execution-optimization information utilizing the collected data may include optimizing data handling, which may be by a data class. In some instances, a data class may include certain data items (datum, byte, bit, a block, a page) that are used once and never again. In other instances, a data class may include certain data items are used constantly but never written and/or infrequently written. In further data classes, certain data items may be constantly read and written to, or other data items may be often being written but never read. The execution-optimization synthesizer 250 operable to generate an execution-optimization information may predict how a data class will likely be used in the future and/or saves the data items in a manner and/or a location that substantially optimizes utilization of the data items by an instruction group and/or storage of the data items by the computing device. Any suitable type of predictive algorithm providing meaningful results may be used, including a predictive algorithm based on a Bayesian method, and/or a learning algorithm. The prediction may be written to a ghost page associated with a piece of data. A prediction may be straight forward if it is known that the data piece will never be written or read. Each data item will expose what its peculiar flavor is. This may be implemented down to the size of a single cache line, or even below the cache line.

In further embodiments, the execution-optimization synthesizer 250 operable to generate an execution-optimization information utilizing the collected data may provide storage mobility for data items that are associated together in a substantial disequilibrium based upon a shared fate, a shared nature, an entanglement to a page and/or line of similarly handled data. The data item may include one or more extra bits (tag) on end of a data item that may indicate its size, nature (written but never read, read but never written, read once in the life of the program, used by at least two threads). In a further embodiment, an indicator may say which code relates with to the data item. This may be used for doing storage assignment. For example, if the data item includes a semaphore that is used across multiple threads, that should be known and the data item managed accordingly. Most data is associated with a particular body of code and assigned to a storage unit together. By watching that, these assignments can be done together between the I-cache and the D-cache.

In an embodiment, the execution-optimization synthesizer 250 further includes an execution-optimization synthesizer operable to save the optimization information. The optimization information may be saved close to the processor 210, for example in an on-chip resource such as the cache A (222), or in the off-chip resource 229, such as a system memory or storage medium. In another embodiment, the execution-optimization synthesizer further includes an execution-optimization synthesizer operable to save the optimization information in an association with the at least one instruction of the instruction set.

In an embodiment, the device 200 includes a computing device, such as for example, the computing device 110 of the computing system environment 100 of FIG. 1. In a further embodiment, the computing device includes at least one of desktop computing device, a laptop-computing device, a portable computing device, and/or a supercomputing device.

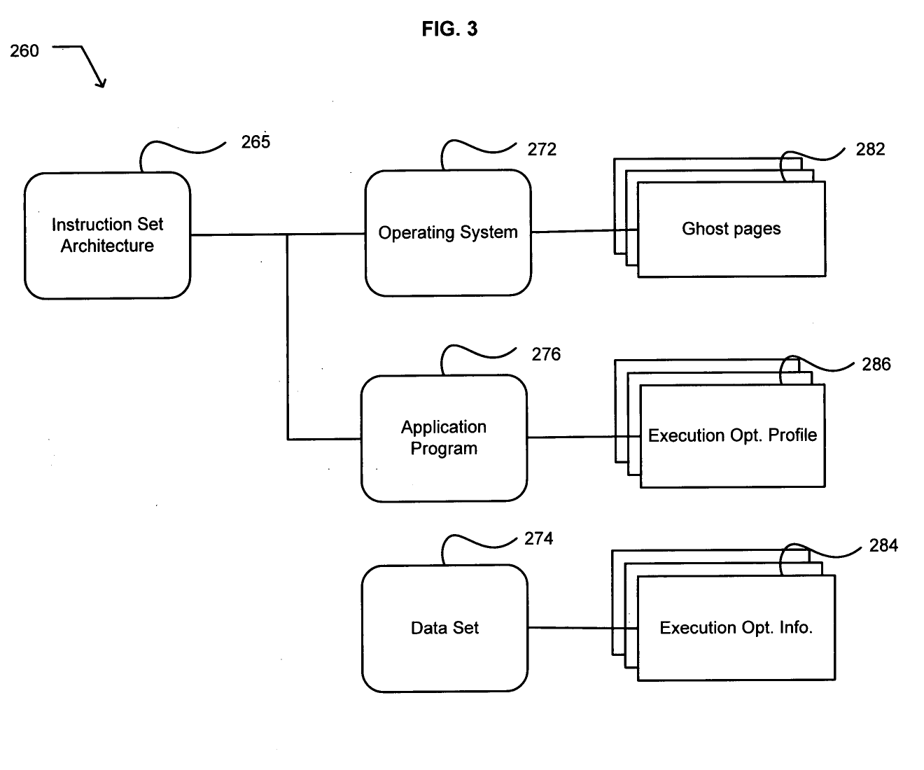

FIG. 3 partially illustrates an association between optimization information and a program and/or data. An instruction set architecture is illustrated as an instruction set architecture 265, and related compiled programs are illustrated as an operating system 272 and an application program 276. The application program 276 may be a compiled application program or a compliable application program. Also illustrated is a data set 274.

The execution-optimization information generated by the execution-optimization synthesizer 250 may be associated with the at least one instruction of the instruction set of a program, an application, and/or a module that includes the at least one instruction. In the case of data, the execution-optimization information generated by the execution-optimization synthesizer may be associated with data received for processing by the execution, data produced by the execution, the at least one instruction of the instruction set that processed the data, and/or other related matter. FIG. 3 illustrates certain embodiments of an association of the execution-optimization information with the at least one instruction of the instruction set. The ghost pages 282 that include the execution-optimization information pertaining to the operating system 272 may be virtually and/or physically associated in an information storage with the operating system. The information storage may include a non-volatile memory structure. For example, the ghost pages may be saved in the same file as the operating system. When the operating system is loaded into system memory, the ghost pages may remain in the information storage, or may be, such as for example, also loaded into system memory, or loaded into an inboard memory. In another embodiment, an execution-optimization information 284 pertaining to a data set 274 is associated in a information storage with the data set. In a further embodiment, an execution-optimization profile 286 is associated in an information storage with an application 276.

In an embodiment, a ghost page of the ghost pages 282 containing the execution-optimization information may be associated with a selected page of a program or data whose content corresponds to the generation of the execution-optimization information, such as for example, a selected page containing the instruction of the operating system 272, a selected page containing the data of the data set 274, and/or a selected page containing the application program 276. By way of further example, data in a ghost page of the ghost pages 282 may indicate that a branch instruction on an identified line of an associated selected page of an application should not be taken. In another embodiment, a file containing the execution-optimization information 284 may be associated with a file containing the data set.

The illustrated embodiments of the ghost page 282, the execution-optimization information 284, and the execution-optimization profile 286 respectively associated with the operating system 272, the data 274, and the application 276 are intended only to be illustrative and are not limiting. In another embodiment for example, the ghost pages 282 may be associated with the application 276, or the data set 274.

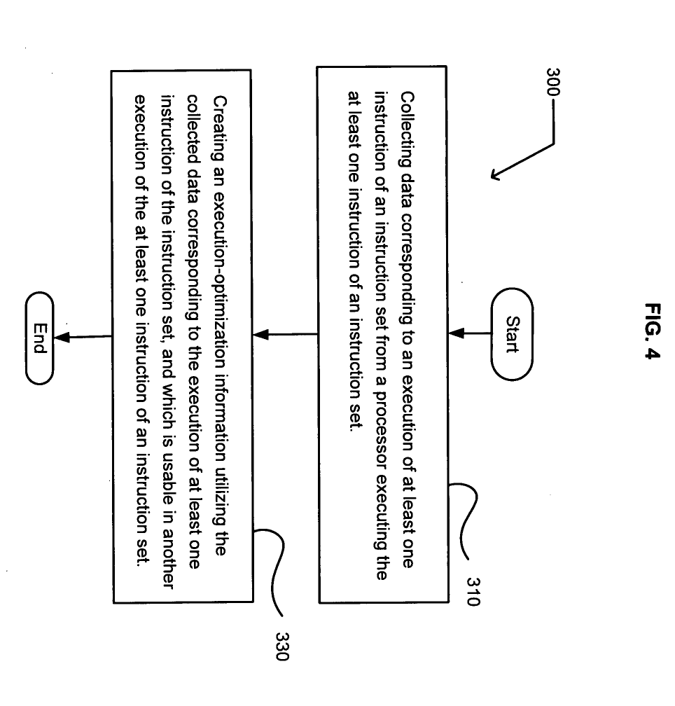

FIG. 4 illustrates an exemplary operational flow 300 in which embodiments may be implemented. In an embodiment, the operational flow may be implemented in the computing system environment 100 of FIG. 1 and/or the device 200 of FIG. 2. After a start operation, the operational flow moves to an accumulation operation 310. The accumulation operation collects data corresponding to an execution of at least one instruction of an instruction set from a processor executing the at least one instruction of an instruction set. An enhancement operation 330 creates an execution-optimization information utilizing the collected data corresponding to the execution of at least one instruction of the instruction set and which is usable in another execution of the at least one instruction of an instruction set. The operational flow then moves to an end operation.

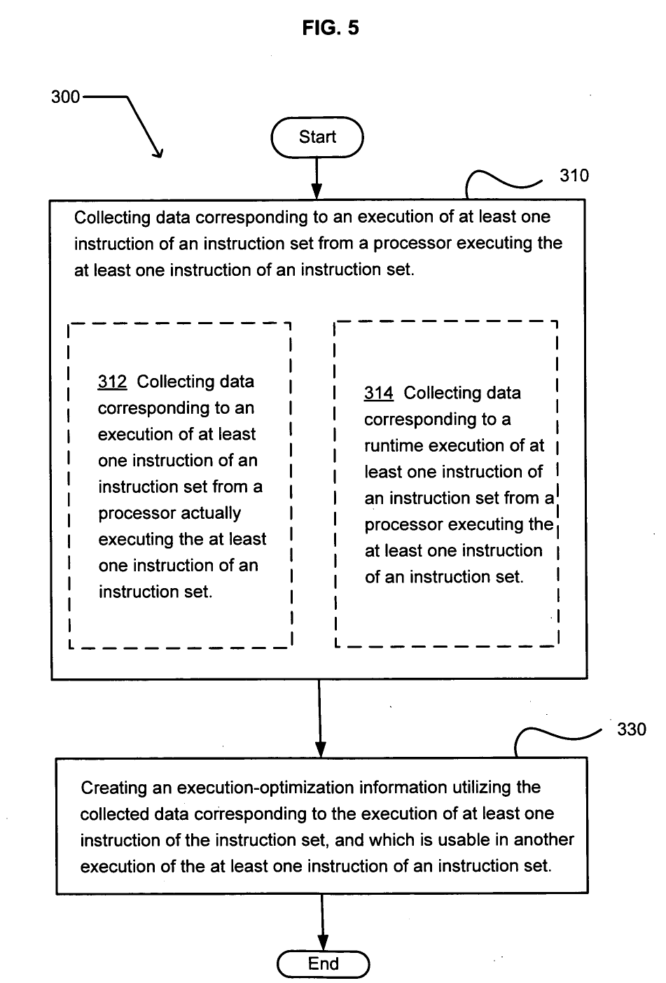

FIG. 5 illustrates an alternative embodiment of the exemplary operational flow 300 of FIG. 4. The accumulation operation 310 may include at least one additional operation. The at least one additional operation may include an operation 312 and/or an operation 314. The operation 312 collects data corresponding to an execution of at least one instruction of an instruction set from a processor actually executing the at least one instruction of an instruction set. The operation 314 collects data corresponding to a runtime execution of at least one instruction of an instruction set from a processor executing the at least one instruction of an instruction set.

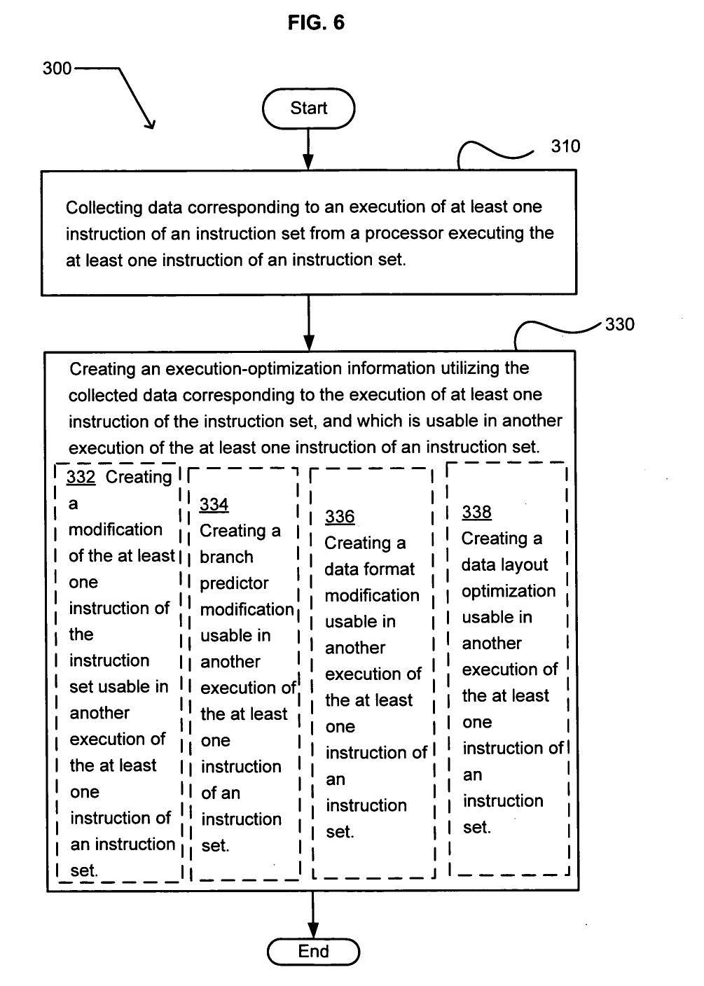

FIG. 6 illustrates another alternative embodiment of the exemplary operational flow 300 of FIG. 4. The enhancement operation 330 may include at least one additional operation. The at least one additional operation may include an operation 332, an operation 334, an operation 336, and/or an operation 338. The operation 332 creates a modification of the at least one instruction of the instruction set usable in another execution of the at least one instruction of an instruction set. For example, the creating a modification of the at least one instruction may include creating one or more versions of the instruction where each version may provide some expected benefit over the original version, or saving a decoded version of a frequently fetched at least one instruction to save a future decoding of the frequently fetched instruction. The operation 334 creates a branch predictor modification usable in another execution of the at least one instruction of an instruction set. The operation 336 creates a data format modification usable in another execution of the at least one instruction of an instruction set. The operation 338 creates a data layout optimization usable in another execution of the at least one instruction of an instruction set. For example, in an embodiment, a data layout optimization may include a repacking of data, a compaction of data, and/or a saving of data that may be useful in execution the at least one instruction.

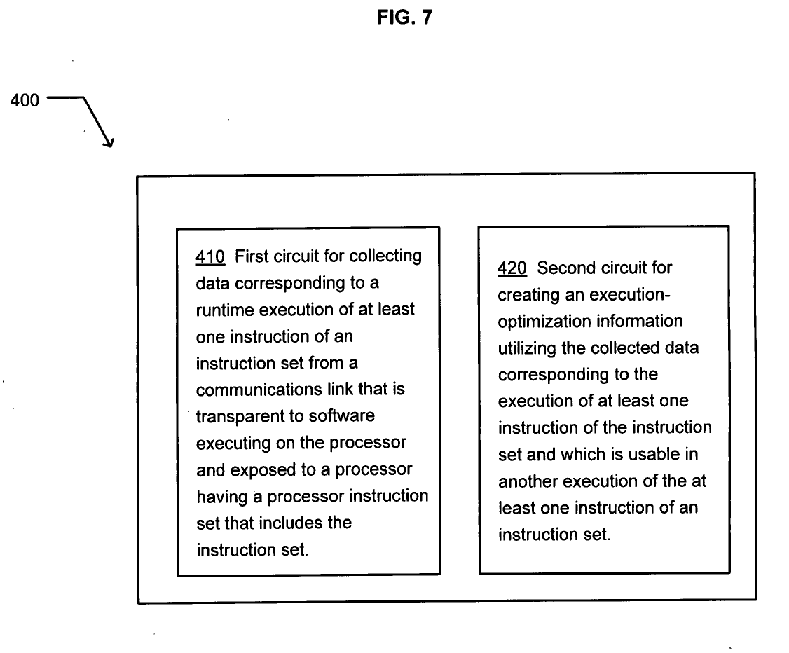

FIG. 7 illustrates a partial view of an exemplary device 400 in which embodiments may be implemented. The device includes a first circuit 410 for collecting data corresponding to a runtime execution of at least one instruction of an instruction set from a communications link that is transparent to software executing on the processor and exposed to a processor having a processor instruction set that includes the instruction set. The device also includes a second circuit 420 for creating an execution-optimization information utilizing the collected data corresponding to the execution of at least one instruction of the instruction set and which is usable in another execution of the at least one instruction of an instruction set. In an embodiment, the second circuit for creating the execution-optimization information includes the first circuit for collecting data corresponding to an execution.

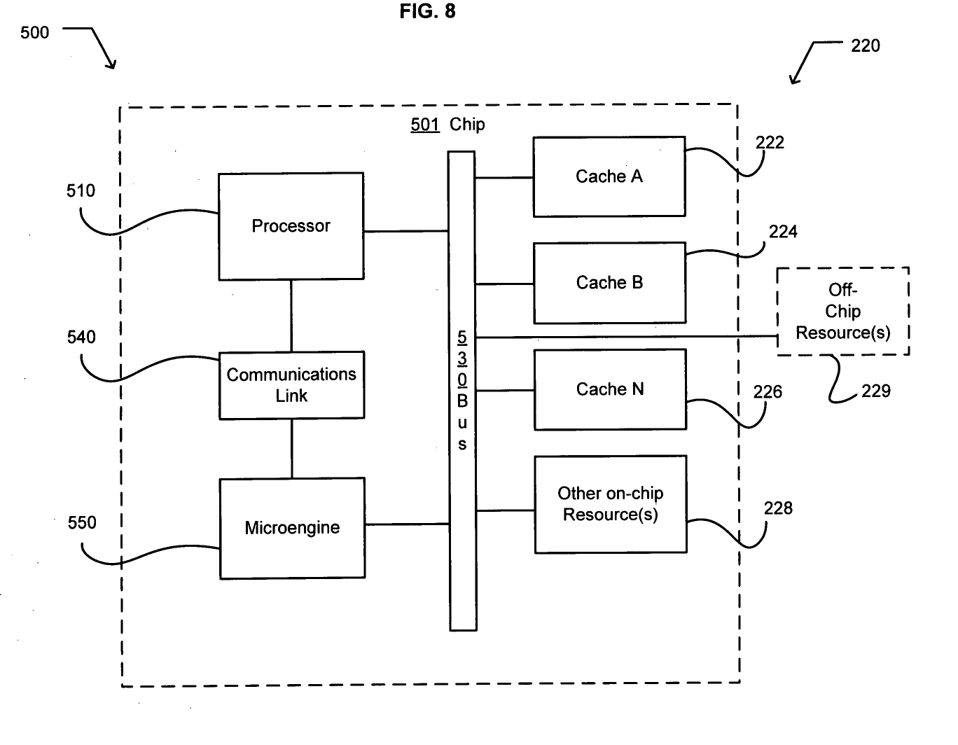

FIG. 8 illustrates a partial view of an exemplary device 500 in which embodiments may be implemented. The device includes a microengine 550 operatively coupled with a processor 510 having an instruction set. The processor may include any processor, such as for example, the processing unit 120 described in conjunction with FIG. 1. The processor may be described as a central processing unit that controls operation of a computer. In an embodiment, the device may include an internal bus 530 providing a parallel data transfer path between the processor and the hardware resource 220.

The microengine 550 includes a microengine operable to gather data in a manner transparent to software executing on the processor 510 and corresponding to a runtime execution of at least a portion of the instruction set by the processor. The microengine is also operable to create a runtime-based optimization profile utilizing the gathered dynamic data and which is useable in a subsequent execution of the at least of a portion of the instruction set by the processor.

In an embodiment, the microengine 550 may include a microengine operable to gather at least one of dynamic data and/or static data in a manner transparent to software executing on the processor and corresponding to a runtime execution of at least a portion of the instruction set by the processor 510.

In another embodiment, the device 500 may further include the processor 510 having an instruction set. In a further embodiment, the processor and the microengine 550 are formed on a chip, illustrated as a single chip 501. In an embodiment, the device may further include a communications link 540 exposed to the microengine. In another embodiment, the device may include the communications link exposed to the microengine and transparent to software executing on the processor. In a further embodiment, the device may include the communications link operably coupled to the microengine and to the processor. In another embodiment, the communications link may include an interconnection structure.

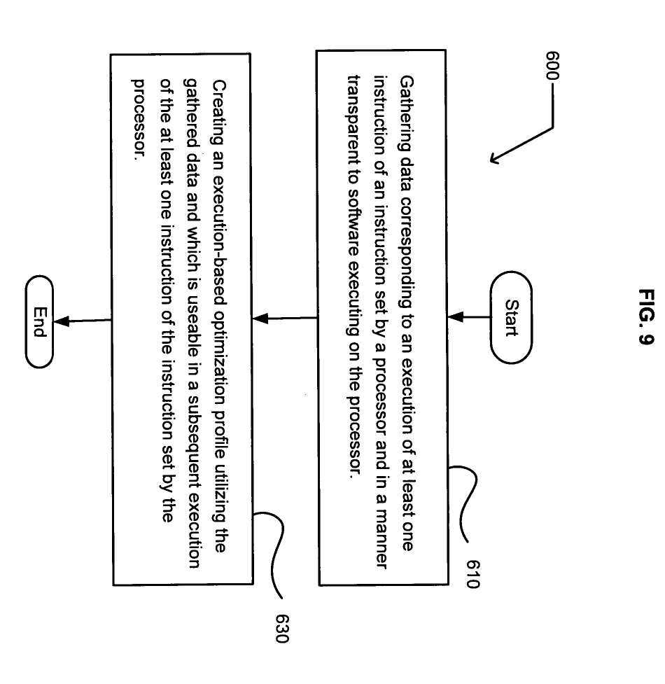

FIG. 9 illustrates an exemplary operational flow 600 implemented in a hardware device and in which embodiments may be implemented. In an embodiment, the operational flow may be implemented in the computing system environment 100 of FIG. 1, and/or the device 500 of FIG. 8. After a start operation, the operational flow moves to a harvesting operation 610. The harvesting operation gathers data corresponding to an execution of at least one instruction of an instruction set by a processor and in a manner transparent to software executing on the processor. An improvement operation 630 creates an execution-based optimization profile utilizing the gathered data and which is useable in a subsequent execution of the at least one instruction of the instruction set by the processor. In an embodiment, the execution-based optimization profile may enhance a future execution of the at least one instruction by increasing an efficiency of the execution, reducing cache misses, reducing exceptions, reducing storage used, and/or reducing energy consumed. The operational flow then proceeds to an end operation.

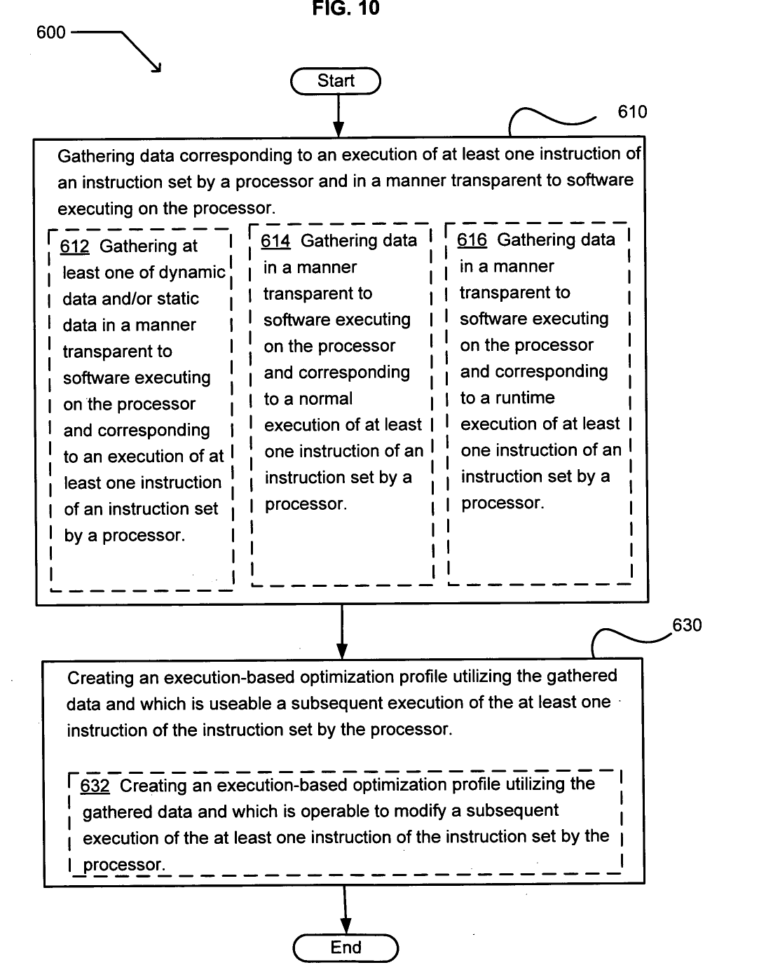

FIG. 10 illustrates an alternative embodiment of the exemplary operational flow 600 of FIG. 9. The harvesting operation 610 may include at least one additional operation. The at least one additional operation may include an operation 612, an operation 614, and/or an operation 616. The operation 612 gathers at least one of dynamic data and/or static data in a manner transparent to software executing on the processor and corresponding to an execution of at least one instruction of an instruction set by a processor. The operation 614 gathers data in a manner transparent to software executing on the processor and corresponding to a normal execution of at least one instruction of an instruction set by a processor. The operation 616 gathers data in a manner transparent to software executing on the processor and corresponding to a runtime execution of at least one instruction of an instruction set by a processor. The improvement operation 630 may include at least one additional operation, such as an operation 632. The operation 632 creates an execution-based optimization profile utilizing the gathered data and which is operable to modify a subsequent execution of the at least one instruction of the instruction set by the processor.

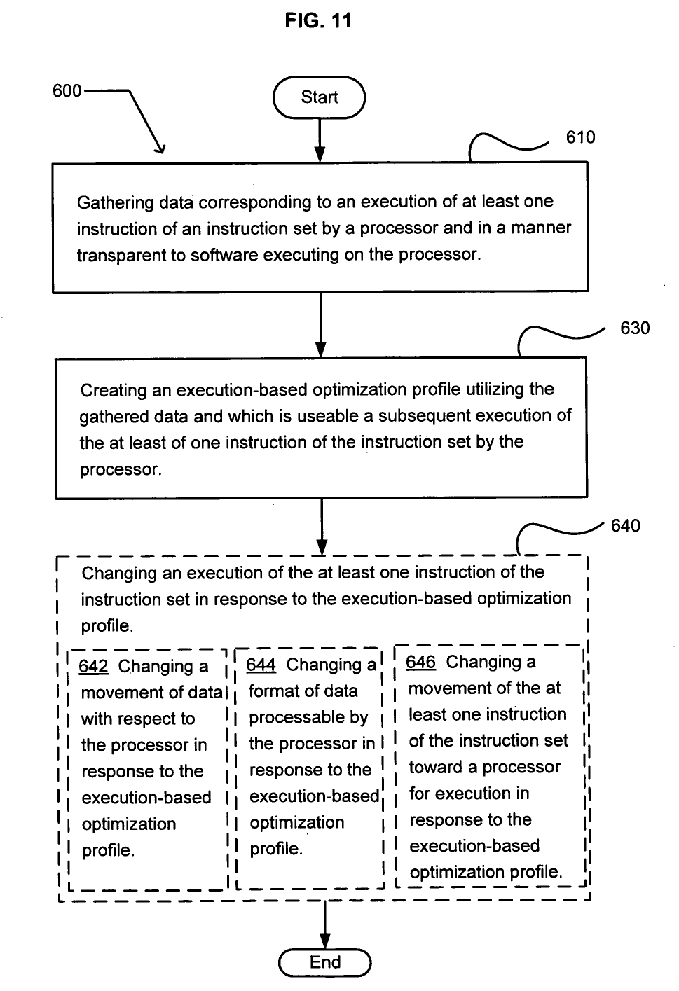

FIG. 11 illustrates another alternative embodiment of the exemplary operational flow 600 of FIG. 9. The operational flow may include at least one additional operation. The at least one additional operation may include a modification operation 640. The modification operation changes an execution of the at least one instruction of the instruction set in response to the execution-based optimization profile.

The modification operation 640 may include at least one additional operation. The at least one additional operation may include an operation 642, an operation 644, and/or an operation 646. The operation 642 changes a movement of data with respect to the processor in response to the execution-based optimization profile. For example, changing a movement of data may include changing a movement of data toward and/or away from the processor. For example, frequently read data may be stored in a memory close to the processor and infrequently read data may be stored in a memory far from the processor. By way of further example, frequently written or rewritten data may be stored in a memory close to the processor and infrequently read data may be stored in a memory far from the processor. The operation 644 changes a format of data processable by the processor in response to the execution-based optimization profile. For example, the operation 644 may save data translated from one format to another, such as from big-endian to little-endian, or floating-point formats. The operation 646 changes a movement of the at least one instruction of the instruction set toward a processor for execution in response to the execution-based optimization profile.

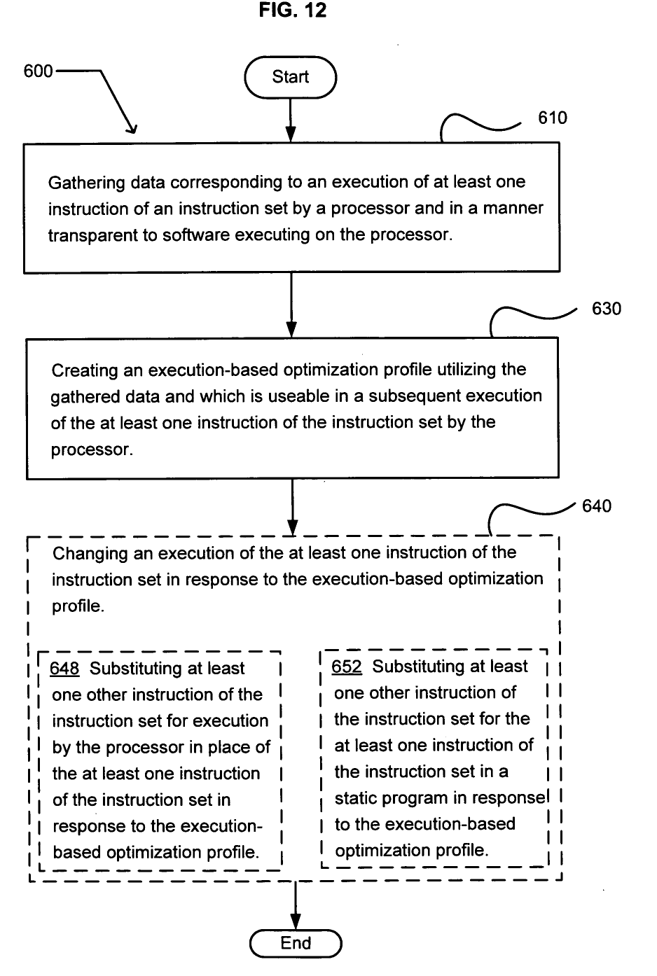

FIG. 12 illustrates a further alternative embodiment of the exemplary operational flow 600 of FIGS. 9 and 11. The modification operation 640 may include at least one additional operation. The at least one additional operation may include an operation 648, and/or an operation 652. The operation 648 substitutes at least one other instruction of the instruction set for execution by the processor in place of the at least one instruction of the instruction set in response to the execution-based optimization profile. The operation 652 substitutes at least one other instruction of the instruction set for the at least one instruction of the instruction set in a static program in response to the execution-based optimization profile.

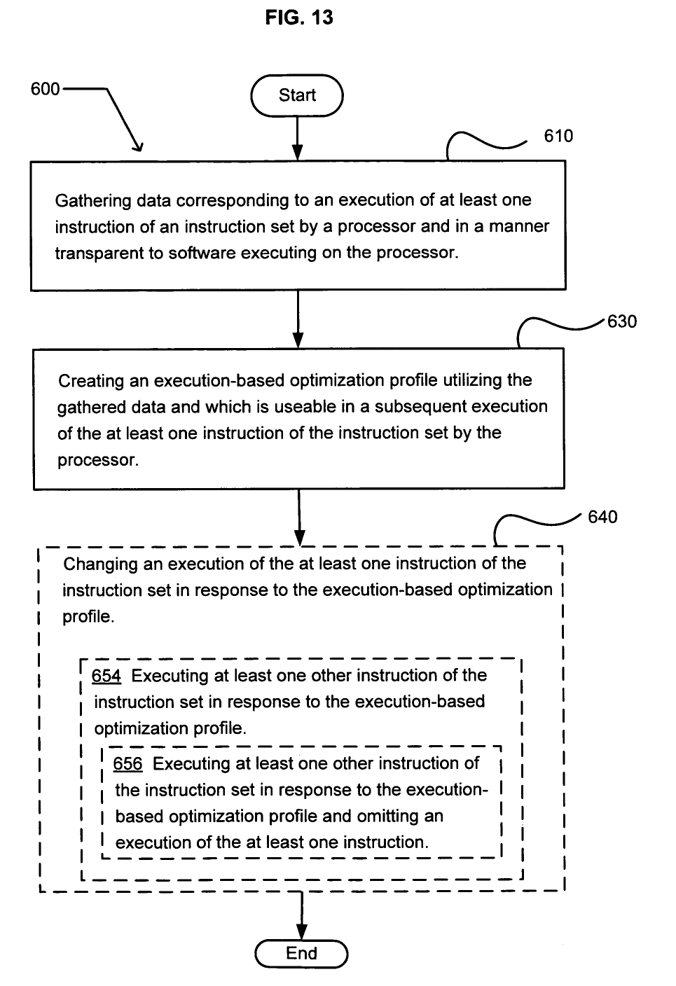

FIG. 13 illustrates an alternative embodiment of the exemplary operational flow 600 of FIGS. 9 and 11. The modification operation 640 may include at least one additional operation. The at least one additional operation may include an operation 654. The operation 654 executes at least one other instruction of the instruction set in response to the execution-based optimization profile. The operation 654 may include at least one additional operation, such as an operation 656. The operation 656 executes at least one other instruction of the instruction set in response to the execution-based optimization profile and omits an execution of the at least one instruction.

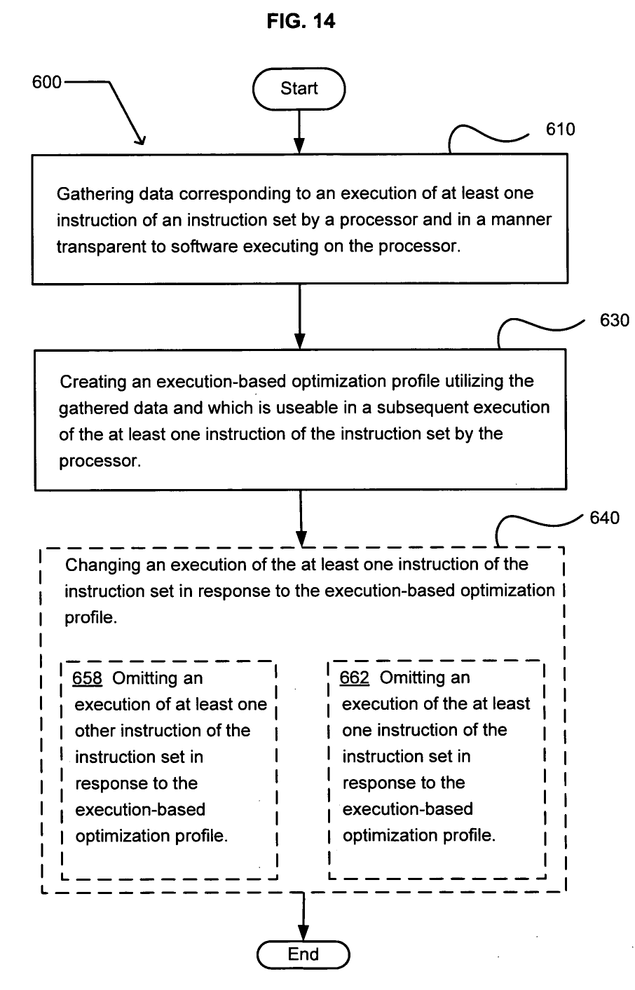

FIG. 14 illustrates another alternative embodiment of the exemplary operational flow 600 of FIGS. 9 and 11. The modification operation 640 may include at least one additional operation. The at least one additional operation may include an operation 658, and/or an operation 662. The operation 658 omits an execution of at least one other instruction of the instruction set in response to the execution-based optimization profile. The operation 662 omits an execution of the at least one instruction of the instruction set in response to the execution-based optimization profile.

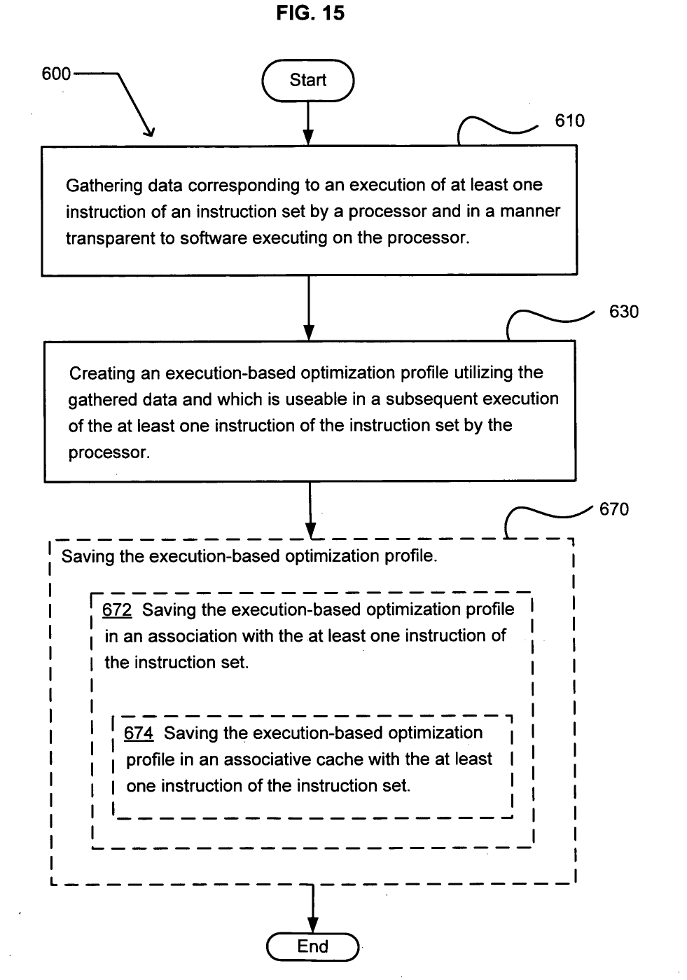

FIG. 15 illustrates another alternative embodiment of the exemplary operational flow 600 of FIG. 9. The operational flow may include at least one additional operation, such as the operation 670. The operation 670 saves the execution-based optimization profile. The operation 670 may include at least one additional operation, such as the operation 672. The operation 672 saves the execution-based optimization profile in an association with the at least one instruction of the instruction set. The operation 672 may include at least one additional operation, such as the operation 674. The operation 674 saves the execution-based optimization profile in an associative cache with the at least one instruction of the instruction set.

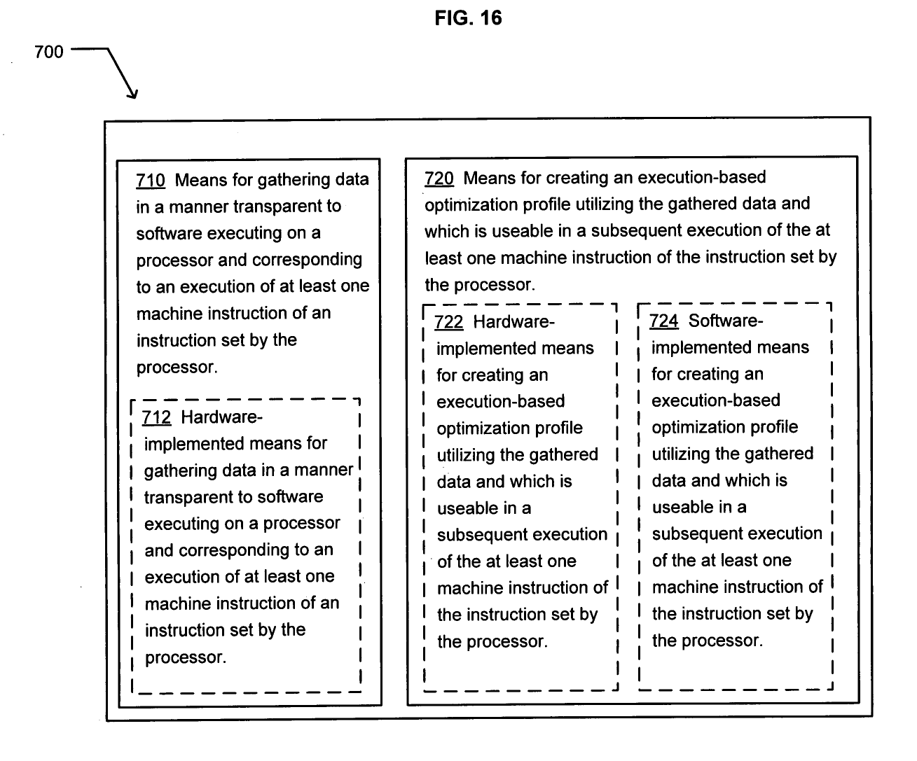

FIG. 16 illustrates a partial view of an exemplary device 700 in which embodiments may be implemented. The device includes means 710 for gathering data in a manner transparent to software executing on the processor and corresponding to an execution of at least one machine instruction of an instruction set by the processor. The device includes means 720 for creating an execution-based optimization profile utilizing the gathered data and which is useable in a subsequent execution of the at least one machine instruction of the instruction set by the processor.

In an alternative embodiment the means 710 includes hardware-implemented means 712 for gathering data in a manner transparent to software executing on a processor and corresponding to an execution of at least one machine instruction of an instruction set by the processor. In another alternative embodiment, the means 720 may include at least one additional means. The at least one additional means may include hardware-implemented means 722 for creating an execution-based optimization profile utilizing the gathered data and which is useable in a subsequent execution of the at least one machine instruction of the instruction set by the processor. The at least one additional means may include software-implemented means 724 for creating an execution-based optimization profile utilizing the gathered data and which is useable in a subsequent execution of the at least one machine instruction of the instruction set by the processor.

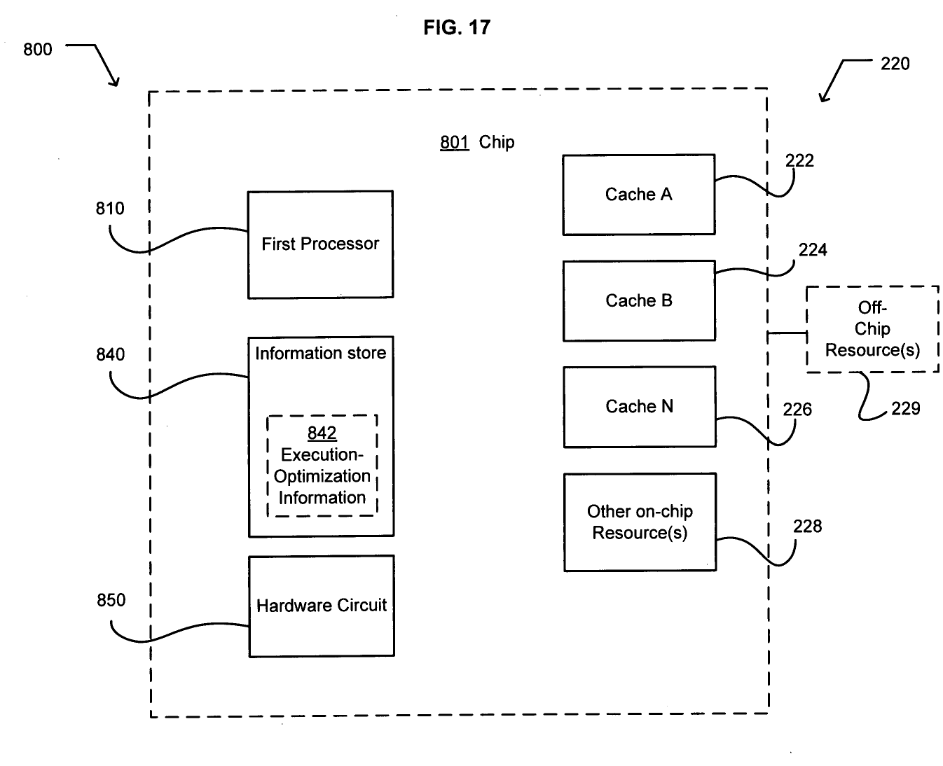

FIG. 17 illustrates a partial view of an exemplary device 800 in which embodiments may be implemented. The device includes an information store 840 operable to save an execution-optimization information 842, a first processor 810, and a hardware circuit 850. The hardware circuit includes a circuit for altering an execution of a program by the first processor in response to the execution-optimization information. The execution-optimization information includes execution-optimization information created by a hardware device utilizing data collected from a second processor (not shown). The collected data corresponding to a previous runtime execution by the second processor of at least a portion of the program that was transparent to any software executing on the second processor.

In an embodiment, the execution-optimization information 842 may include the execution-optimization information generated by the execution-optimization synthesizer 250 of FIG. 2. In another embodiment, the execution-optimization information may include at least one of the ghost pages 272, the execution-optimization information 274, and/or the execution-optimization profile 276 described in conjunction with FIGS. 2 and 3. In an alternative embodiment, the first processor 810 includes a first processor operable to execute an instruction set and operably coupled to the information store 840. In another embodiment, the hardware circuit for altering an execution of a program includes a hardware circuit for altering an execution of a program and operably coupled to the information store. In a further embodiment, the hardware circuit includes a hardware circuit operably coupled to the processor.

In an embodiment, the hardware circuit 850 includes a hardware circuit for copying the execution-optimization information from the information store to a memory operably coupled to the first processor. For example, the memory operably coupled to the first processor may include the hardware resource 220, such as the on-chip cache B 224, or the off-chip resource 229, such as an off-chip cache or an outboard memory or an outboard storage.

In a further embodiment, the hardware circuit 850 for altering an execution of a program by the first processor 810 in response to the execution-optimization information includes a hardware circuit for causing an alteration of an execution of at least one instruction of an instruction set of a static program by the first processor in response to the execution-optimization information. In another embodiment, the altering an execution of a program by the first processor in response to the execution-optimization information includes altering an execution of at least one instruction of an instruction set of a dynamic program by the first processor in response to the execution-optimization information. In a further embodiment, the altering an execution of a program by the first processor in response to the execution-optimization information includes altering a context of an execution of a program by the first processor in response to the execution-optimization information.

In an embodiment, the hardware circuit for altering an execution of a program by the first processor in response to the execution-optimization information includes a hardware circuit for altering an execution of at least one instruction of an instruction set of a program by the first processor in response to the execution-optimization information. In another embodiment, the hardware circuit for altering an execution of a program by the first processor in response to the execution-optimization information includes a hardware circuit for altering a movement of data with respect to the first processor in response to the execution-optimization information. In a further embodiment, the hardware circuit for altering an execution of a program by the first processor in response to the execution-optimization information includes a hardware circuit for altering a movement of at least one instruction of the program toward the first processor in response to the execution-optimization information.

In some instances, the altering an execution of a program by the first processor in response to the execution-optimization information may include directly altering an execution of a program by the first processor in response to the execution-optimization information. In other instances, the altering an execution of a program by the first processor in response to the execution-optimization information may include causing an alteration of an execution of a program by the first processor in response to the execution-optimization information. In further instances, the altering an execution of a program by the first processor in response to the execution-optimization information may include initiating an alteration of an execution of a program by the first processor in response to the execution-optimization information.

In an embodiment, the execution-optimization information includes execution-optimization information created by a hardware device (not shown) utilizing data collected from a second processor (not shown) that is at least substantially a same processor as the first processor 810. For example, the execution-optimization information used to alter a current execution of a program by the first processor 810 may have been created during a prior execution of the program by the first processor. In another embodiment, the execution-optimization information includes an execution-optimization information created by a hardware device utilizing data collected from a second processor that is at least a substantially different processor from the first processor. For example, the execution-optimization information used to alter a current execution of a program by the first processor may have been created during a prior execution of the program by a completely different second processor, which may be a processor running in a completely different computing device.

In an embodiment, the information store includes at least a portion of a cache. In another embodiment, the information store includes at least one of an I-cache or a D-cache. In a further embodiment, the information store includes at least one of a volatile memory or a non-volatile memory. In a further embodiment, the information store includes a computer readable medium. In another embodiment, the information store may include a non-volatile outboard storage, such as magnetic disk storage.

In another embodiment, the first processor 810 and the hardware circuit 850 are formed on a single chip, illustrated as a single chip 801. In a further embodiment, the first processor 810 and the information store 840 are formed on a single chip, illustrated as a single chip 801.

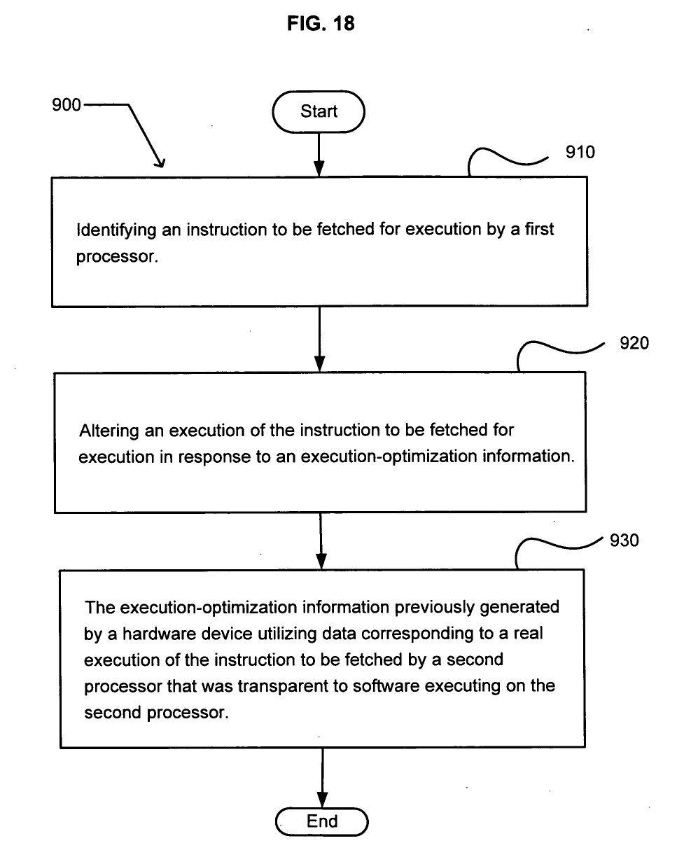

FIG. 18 illustrates an exemplary operational flow 900 that may implement embodiments. In an embodiment, the operational flow may be implemented in the computing system environment 100 of FIG. 1, and/or the device 800 of FIG. 17. After a start operation, the operational flow moves to an instruction determination operation 910. The instruction determination operation identifies an instruction to be fetched for execution by a first processor. An optimization operation 920 alters an execution of the instruction to be fetched for execution in response to an execution-optimization information. The execution-optimization information 930 was previously generated by a hardware device utilizing data corresponding to a real execution of the instruction to be fetched by a second processor that was transparent to software executing on the second processor. The flow then moves to an end operation.

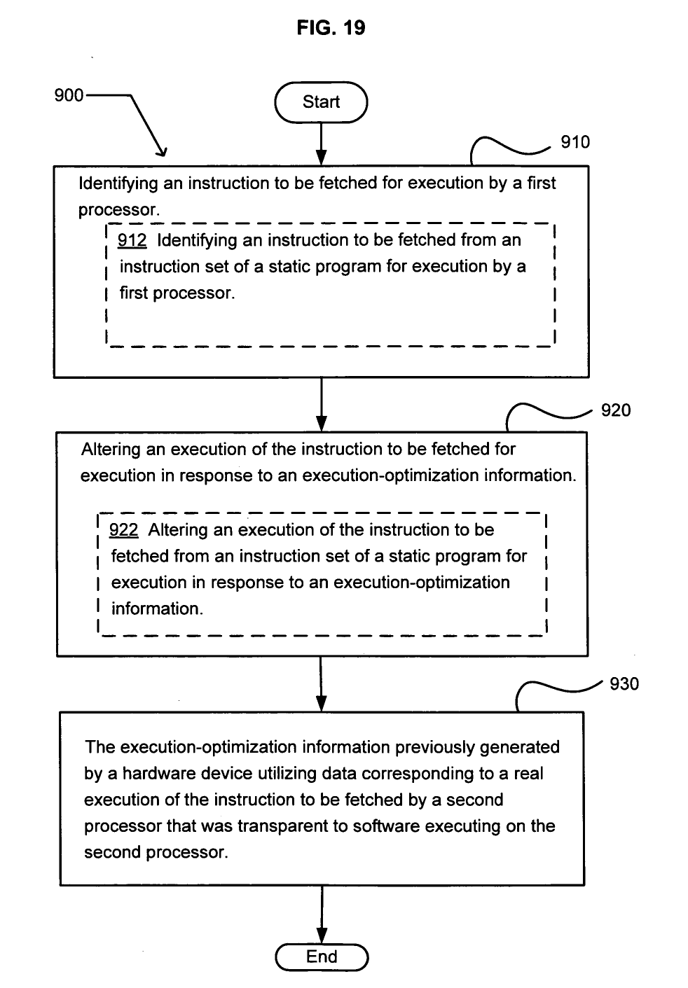

FIG. 19 illustrates an alternative embodiment of the exemplary operational flow 900 of FIG. 18. The instruction determination operation 910 may include at least one additional operation, such as an operation 912. The operation 912 identifies an instruction to be fetched from an instruction set of a static program for execution by a first processor. The optimization operation 920 may include at least one additional operation, illustrated as the operation 922. The operation 922 alters an execution of the instruction to be fetched from an instruction set of a static program for execution in response to an execution-optimization information.

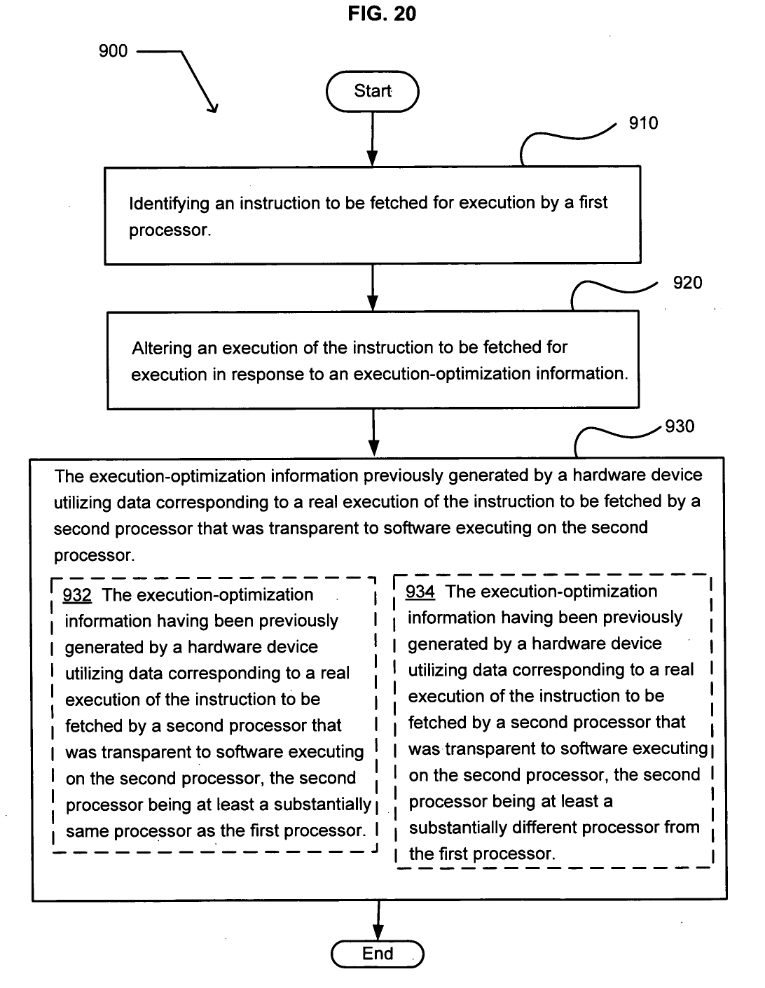

FIG. 20 illustrates an alternative embodiment of the exemplary operational flow 900 of FIG. 18. The execution-optimization information 930 may include at least one additional embodiment. The at least one additional embodiment may include an execution-optimization information 932 and/or an execution-optimization information 934. The execution-optimization information 932 includes execution-optimization information having been previously generated by a hardware device utilizing data corresponding to a real execution of the instruction to be fetched by a second processor that was transparent to software executing on the second processor, the second processor being at least a substantially same processor as the first processor. The execution-optimization information 934 may include an execution-optimization information having been previously generated by a hardware device utilizing data corresponding to a real execution of the instruction to be fetched by a second processor that was transparent to software executing on the second processor, the second processor being at least a substantially different processor from the first processor. In an embodiment, the second processor may be a processor of a multiprocessor computing device that includes the first processor. In another embodiment, the second processor may be a processor of a second computing device that is a separate and distinct computing device from a first computing device that includes the first processor.

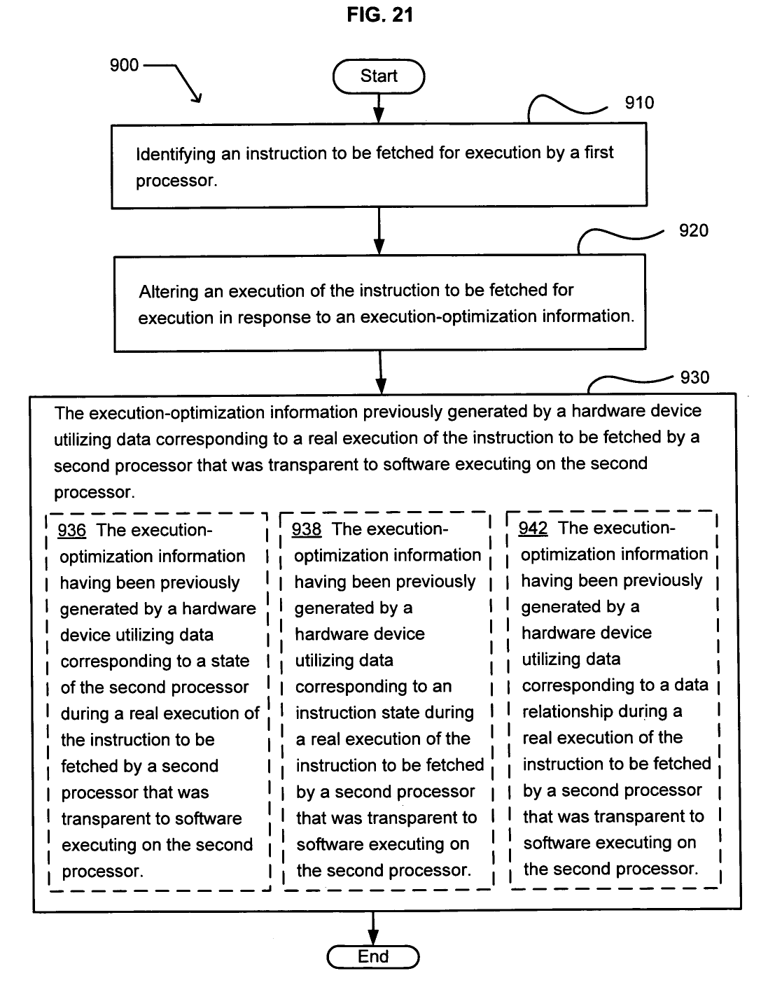

FIG. 21 illustrates an alternative embodiment of the exemplary operational flow 900 of FIG. 18. The execution-optimization information 930 may include at least one additional embodiment. The at least one additional embodiment may include an execution-optimization information 936, an execution-optimization information 938, and/or an execution-optimization information 942. The execution-optimization information 936 includes an execution-optimization information having been previously generated by a hardware device utilizing data corresponding to a state of the second processor during a real execution of the instruction to be fetched by a second processor that was transparent to software executing on the second processor. The execution-optimization information 938 includes an execution-optimization information having been previously generated by a hardware device utilizing data corresponding to an instruction state during a real execution of the instruction to be fetched by a second processor that was transparent to software executing on the second processor. The execution-optimization information 942 includes an execution-optimization information having been previously generated by a hardware device utilizing data corresponding to a data relationship during a real execution of the instruction to be fetched by a second processor that was transparent to software executing on the second processor.

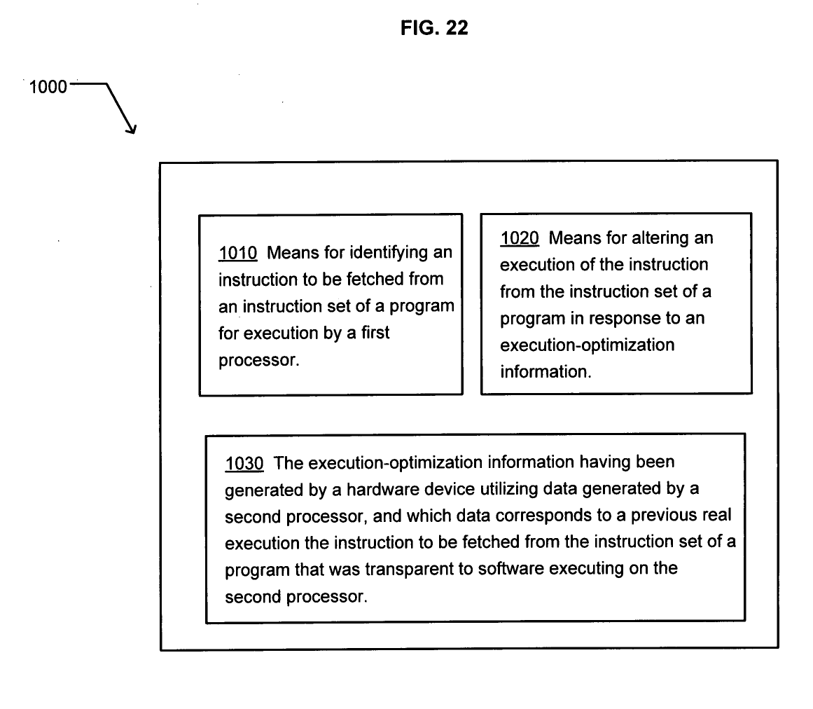

FIG. 22 illustrates a partial view of an exemplary device 1000 in which embodiments may be implemented. The device includes means 1010 for identifying an instruction to be fetched from an instruction set of a program for execution by a first processor. The device also includes means 1020 for altering an execution of the instruction from the instruction set of a program in response to an execution-optimization information. The execution-optimization information 1030 having been generated by a hardware device utilizing data generated by a second processor, and which data corresponds to a previous real execution the instruction to be fetched from the instruction set of a program that was transparent to software executing on the second processor.

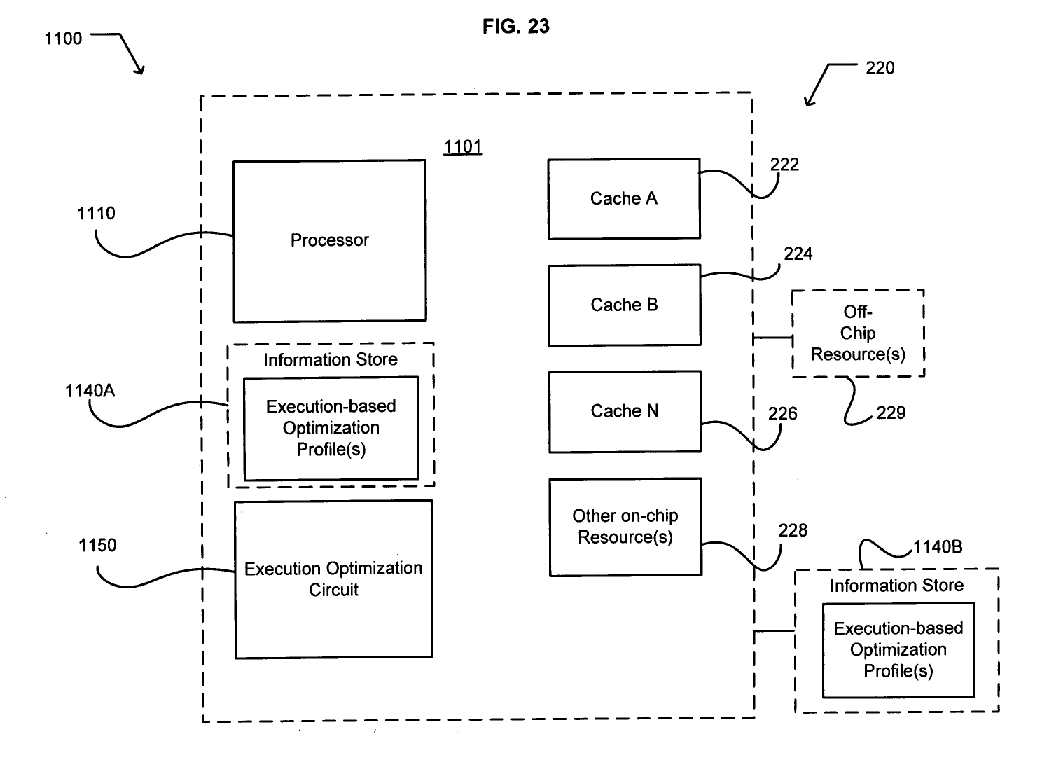

FIG. 23 illustrates a partial view of an exemplary device 1100 in which embodiments may be implemented. The device includes a processor 1110 operable to execute an instruction set, and an execution-optimization circuit 1150. The execution-optimization circuit includes an execution-optimization circuit for receiving an identification of a first instruction to be fetched from the instruction set for execution by the processor. The execution-optimization circuit also includes an execution-optimization circuit for pointing to a second instruction of the instruction set of the processor to be fetched for execution by the processor if indicated by an execution-based optimization profile saved in an information store. In an embodiment, the information store may include an information store 1140A close to the processor, such as on the same chip. In another embodiment, the information store may include an information store 1140B that is an off-processor-chip resource. The execution-based optimization profile being previously derived by a hardware device utilizing data invisible to software and generated during a runtime execution of at least a portion of the instruction set. The execution-based optimization profile may indicate that the second instruction be fetched in a direct and/or indirect manner. For example, the execution-based optimization profile may modify the next instruction address calculation causing the second instruction to be fetched in lieu of the first instruction. In another example, the execution-based optimization profile may signal and/or point the next instruction address calculation causing the second instruction to be fetched in lieu of the first instruction. In a further example, the execution-based optimization profile may provide information usable in determining whether to fetch the second instruction in lieu of the first instruction.

In an embodiment, the execution-optimization circuit 1150 includes at least one of a microengine, a micro-programmed circuit, and/or a hardwired circuit. In another embodiment, the execution-optimization circuit includes an execution-optimization portion of a control unit of the processor. In a further embodiment, the processor and the execution-optimization circuit are formed on a chip, illustrated as the chip 1101.

In an embodiment, the execution-optimization circuit 1150 includes an execution-optimization circuit for receiving an identification of a first instruction to be fetched from the instruction set of a program for execution by the processor. The program may be a static program or a dynamic program. In another embodiment, the execution-optimization circuit includes an execution-optimization circuit for pointing to a second instruction of the instruction set of the processor to be fetched for execution by the processor if indicated by an execution-based optimization profile associated with the first instruction. In a further embodiment, the execution-optimization circuit includes an execution-optimization circuit for pointing to a second instruction of the instruction set of the processor to be fetched for execution by the processor if indicated by an execution-based optimization profile associated with another instruction of the instruction set. In an embodiment, the execution-based optimization profile includes the execution-based optimization profile being previously derived by a hardware device utilizing data invisible to software and generated during a runtime execution of at least a portion of an instruction set of a static program.

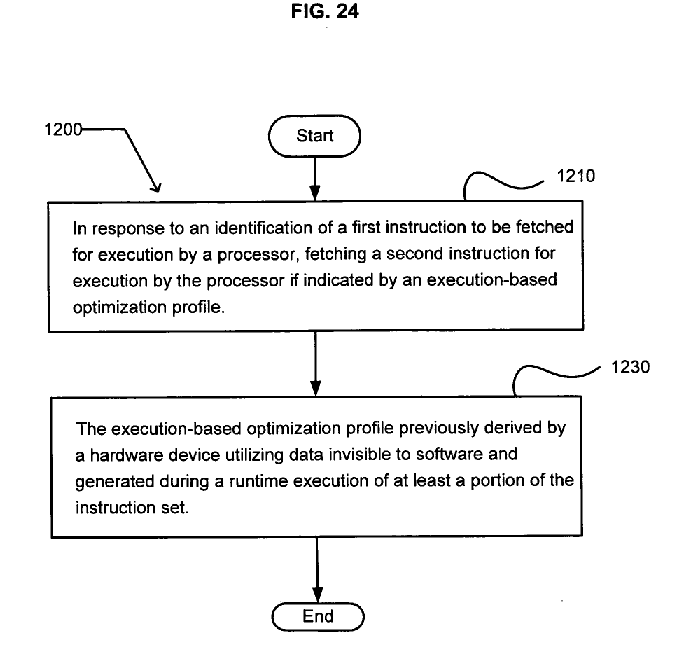

FIG. 24 illustrates an exemplary operational flow 1200 in which embodiments may be implemented. In an embodiment, the operational flow may be implemented in the computing system environment 100 of FIG. 1, and/or the device 1100 of FIG. 23. After a start operation, the operational flow moves to a substitution operation 1210. In response to an identification of a first instruction to be fetched for execution by a processor, the substitution operation fetches a second instruction for execution by the processor if indicated by an execution-based optimization profile. The execution-based optimization profile 1230 includes an execution-based optimization profile previously derived by a hardware device utilizing data invisible to software and generated during a runtime execution of at least a portion of the instruction set. The flow then proceeds to an end operation. The operational flow is transparent to software executing on the processor.

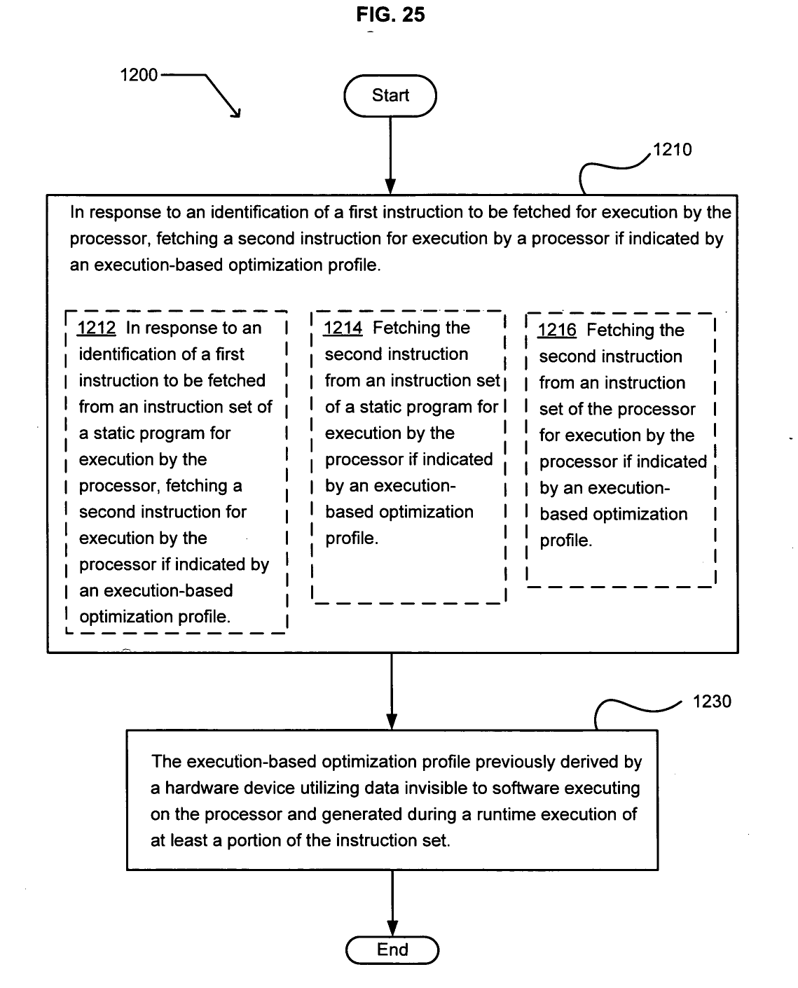

FIG. 25 illustrates an alternative embodiment of the exemplary operational flow 1200 of FIG. 24. The substitution operation 1210 may include at least one additional operation. The at least one additional operation may include an operation 1212, an operation 1214, and/or an operation 1216. In response to an identification of a first instruction to be fetched from an instruction set of a static program for execution by the processor, the operation 1212 fetches a second instruction for execution by the processor if indicated by an execution-based optimization profile. In response to an identification of a first instruction to be fetched from an instruction set of a static program for execution by the processor, the operation 1214 fetches the second instruction from an instruction set of a static program for execution by the processor if indicated by an execution-based optimization profile. In response to an identification of a first instruction to be fetched from an instruction set of a static program for execution by the processor, the operation 1216 fetches the second instruction from an instruction set of the processor for execution by the processor if indicated by an execution-based optimization profile.

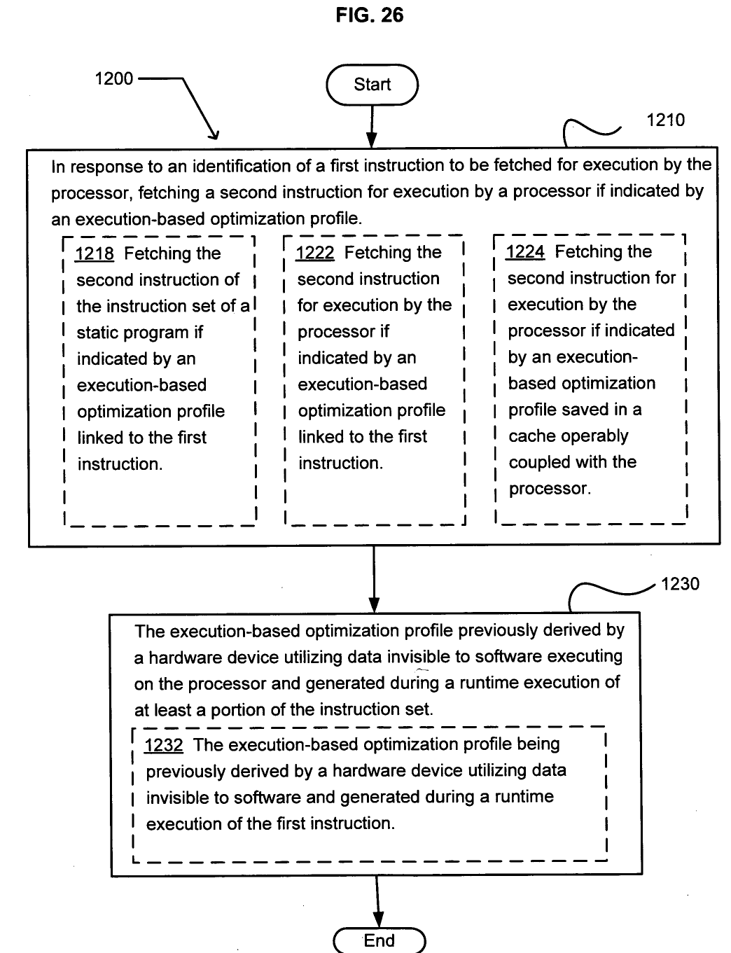

FIG. 26 illustrates another alternative embodiment of the exemplary operational flow 1200 of FIG. 24. The substitution operation 1210 may include at least one additional operation. The at least one additional operation may include an operation 1218, an operation 1222, and/or an operation 1224. In response to an identification of a first instruction to be fetched from an instruction set of a static program for execution by the processor, the operation 1218 fetches the second instruction of the instruction set of a static program if indicated by an execution-based optimization profile linked to the first instruction. In response to an identification of a first instruction to be fetched from an instruction set of a static program for execution by the processor, the operation 1222 fetches a second instruction for execution by the processor if indicated by an execution-based optimization profile linked to the first instruction. In response to an identification of a first instruction to be fetched from an instruction set of a static program for execution by the processor, the operation 1224 fetches the second instruction for execution by the processor if indicated by an execution-based optimization profile saved in a cache operably coupled with the processor. The execution-based optimization profile 1230 may include at least one additional execution-based optimization profile, such as an execution-based optimization profile 1232. The execution-based optimization profile 1232 includes an execution-based optimization profile being previously derived by a hardware device utilizing data invisible to software and generated during a runtime execution of the first instruction.

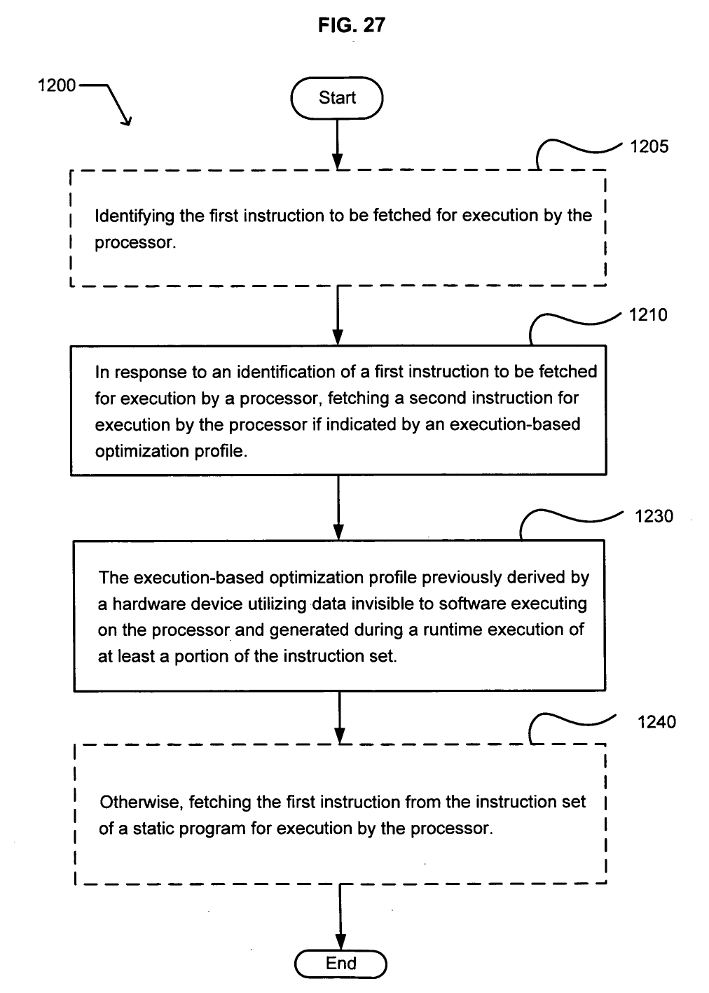

FIG. 27 illustrates a further alternative embodiment of the exemplary operational flow 1200 of FIG. 24. The operational flow may include at least one additional operation. The at least one additional operation may include a fetch next instruction operation 1205, and/or an operation 1240. The fetch next instruction operation 1205 identifies the first instruction to be fetched for execution by the processor. If fetching a second instruction for execution by the processor is not indicated by the execution-based optimization profile, the operation 1240 fetches the first instruction from the instruction set of a static program for execution by the processor.

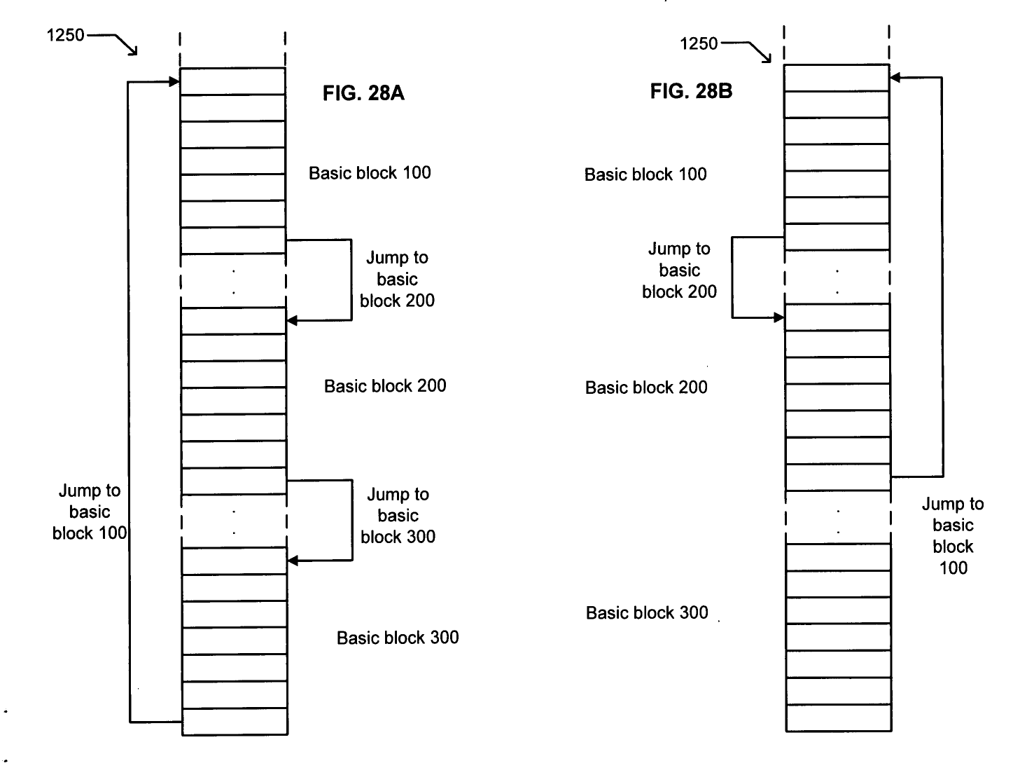

FIG. 28 illustrates an alternative embodiment of the exemplary operational flow 1200 of FIG. 24, and includes FIGS. 28A and 28B. FIG. 28A illustrates an instruction group 1250, which includes a basic block 100, a basic block 200, and a basic block 300. The execution sequence of the instruction group includes a jump from the last instruction of the basic block 100 to the first instruction of the basic block 200, a jump from the last instruction of the basic block 200 to the first instruction of the basic block 300, and a jump from the last instruction of the basic block 300 to the first instruction of the basic block 100 until a condition is met.

FIG. 28B illustrates a modification of the instruction group 1250 in response to a hardware-generated and historically-based execution-optimization strategy. For example, the optimization strategy may have been created in response to data collected from a processor indicating that a result produced by execution of the basic block 300 is never read. In an embodiment, the optimization strategy may include using at least one of the execution-optimization information described in conjunction with FIGS. 2, 4, 17, and 18; a runtime-based optimization profile described in conjunction with FIG. 8; and/or an execution-based optimization profile described in conjunction with FIGS. 9, 23, and 24. If indicated by the optimization strategy, the execution sequence of the instruction group includes a jump from the last instruction of the basic block 100 to the first instruction of the basic block 200, and jump from the last instruction of the basic block 200 to the first instruction of the basic block 100 until a condition is met. The execution of the basic block 300 is omitted or not executed.

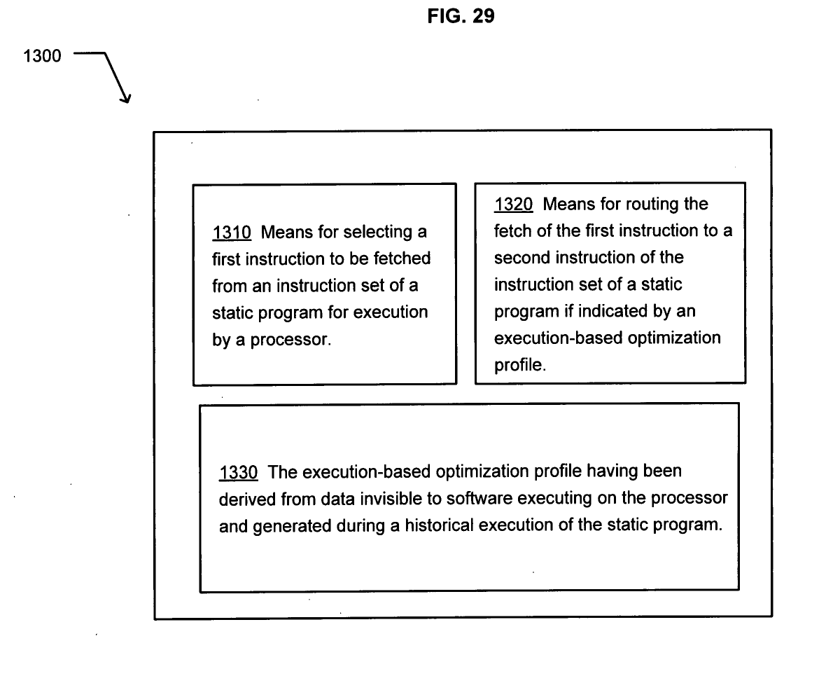

FIG. 29 illustrates a device 1300 in which embodiments may be implemented. The device includes means 1310 for selecting a first instruction to be fetched from an instruction set of a static program for execution by a processor. The device also includes means 1320 for routing the fetch of the first instruction to a second instruction of the instruction set of a static program if indicated by an execution-based optimization profile. The execution-based optimization profile 1330 includes an execution-based optimization profile having been derived from data invisible to software and generated during a historical execution of the static program.

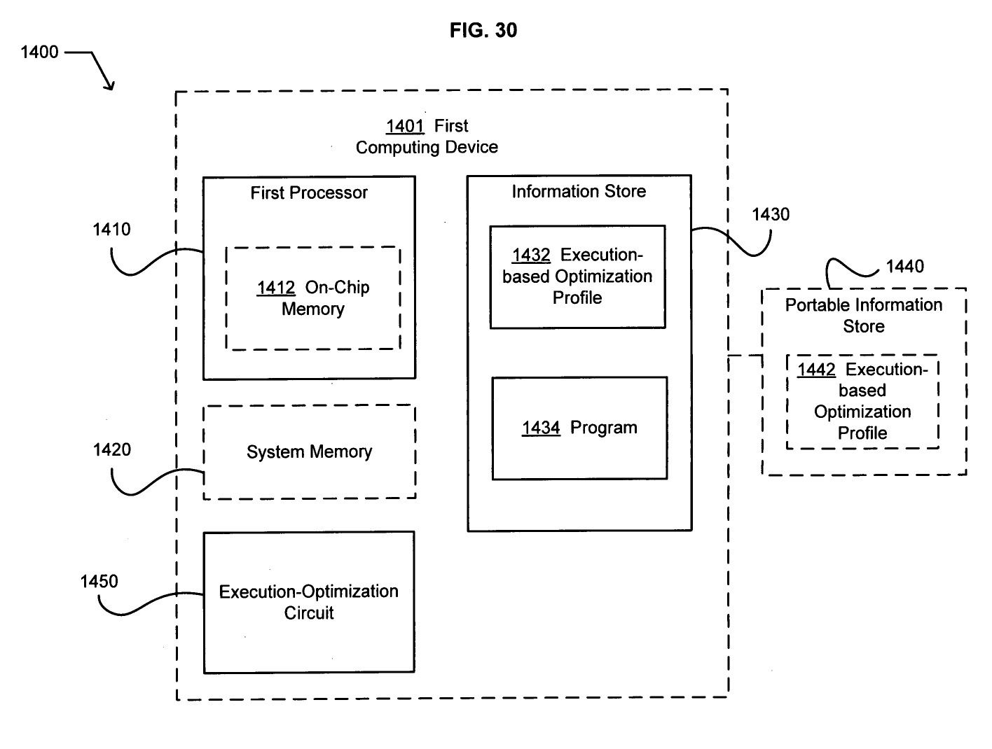

FIG. 30 illustrates a partial view of an exemplary apparatus 1400 in which embodiments may be implemented. The apparatus includes a first processor operable to execute a program, an embodiment of which is illustrated as a first processor 1410, an information store, an embodiment of which is illustrated as an information store 1430, and an execution-optimization circuit, an embodiment of which is illustrated as an execution-optimization circuit 1450. In an alternative embodiment, the apparatus may include a system memory 1420 and/or an on-chip memory 1412.

The first processor 1410 is operable to execute a program, illustrated as the program 1434 saved in the information store 1430. The first processor includes a first processor operable to execute an instruction set and/or having a first instruction set architecture. The first processor may include any processing unit, and may be described as a central processing unit that controls operation of a computer, such as for example, the processing unit 120 described in conjunction with FIG. 1.

The information store 1430 includes an information store configured by an execution-based optimization profile, an embodiment of which is illustrated as an execution-based optimization profile 1432. In an embodiment, the information store may be configured by writing bits of data representing the execution-based optimization profile on the information store. In another embodiment, the information store may be configured by flashing bits of data representing the execution-based optimization profile on the information store.

The execution-based optimization profile 1432 includes an execution-based optimization profile that is usable in an execution of the program, and that was created utilizing data collected during a runtime execution of the program by a second processor (not shown) and transparent to software executing on the second processor. For example, in an embodiment, the second processor may include the processor 510 described in conjunction with FIG. 8, and the execution-based optimization profile may have been created as described in conjunction with FIGS. 8 and 9. In an embodiment, the execution-based optimization profile may have another provenance. For example, the execution-based optimization profile may have a provenance that includes a derivation from other information responsive to a runtime execution of the program. In a further embodiment, the execution-based optimization profile may include one or more execution-based optimization profiles described elsewhere in this document.

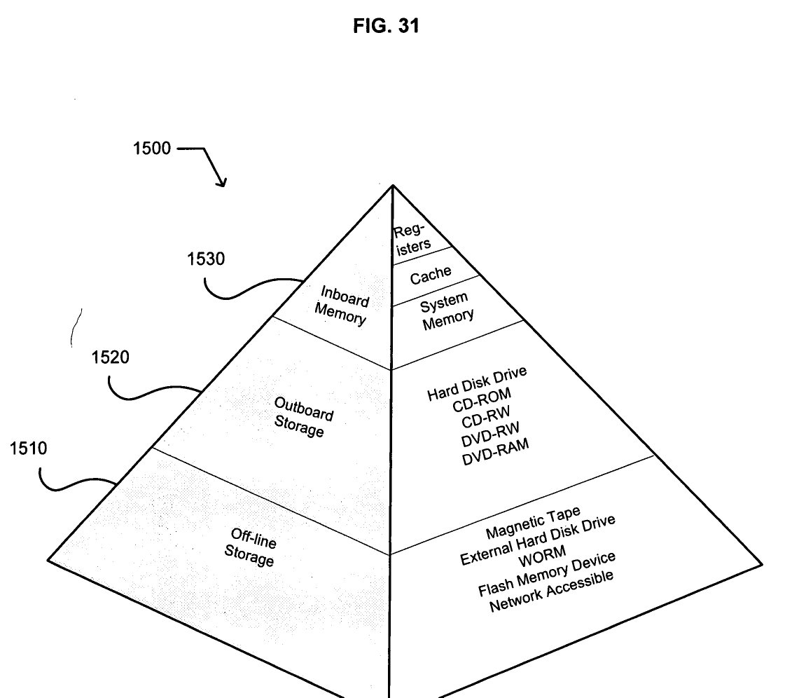

In an embodiment, the information store 1430 may include any suitable computer-readable media. FIG. 31 partially illustrates an embodiment of an information store hierarchy 1500 of computer-readable media. An off-line storage 1510 may include a magnetic tape, an external hard disk drive, a flash memory card, and/or a network accessible information store, such as an Internet site. An outboard storage 1520 may include an internal hard disk drive, such as the hard disk drive 141 and/or a mounted portable storage medium, such as the non-volatile magnetic disk 152, and/or a mounted removable optical media, such as the optical disk 156, all as described in conjunction with FIG. 1. An inboard memory 1530 may include a system memory, such as the system memory 130 or the system memory 1420 described in conjunction with FIGS. 1 and 30 respectively. The inboard memory may also include an on-chip memory, such as a cache and/or a register, illustrated as the on-chip memory 1412 of FIG. 30.

In another embodiment, the information store configured by an execution-based optimization profile includes an information store configured by a portable execution-based optimization profile, such as the execution-based optimization profile 1442 carried by a portable information store 1440 as depicted in FIG. 30. The portable information store may include any form of portable off-line storage 1510 and/or mountable portable outboard storage 1520 described in conjunction with FIG. 31, and/or described in conjunction with FIG. 1. For example, an embodiment of the portable information store may include a flash memory device, such as a flash memory card configured by the execution-based optimization profile. By way of further example, an embodiment of the portable information store may include an optical disk, such as a DVD configured by the execution-based optimization profile.

The execution-optimization circuit 1450 includes an execution-optimization circuit operable to alter an execution of the program 1434 by the first processor 1410 in response to the execution-based optimization profile 1432. In an embodiment, the first processor operable to execute a program includes a first computing device 1401 having a first processor operable to execute a program as shown in FIG. 30.

In a further embodiment, a provenance of the execution-based optimization profile 1432 includes an execution-based optimization profile usable in an execution of the program and that was created utilizing data collected by a hardware device during a runtime execution of the program by a second processor and transparent to software executing on the second processor. The hardware device may include the execution optimization synthesizer 250 described in conjunction with FIG. 2. In another embodiment, the hardware device may include a micro-engine.

In an embodiment, a provenance of the execution-based optimization profile 1432 includes an execution-based optimization profile usable in an execution of the program and generated utilizing data collected during a runtime execution of the program by a second processor and transparent to software executing on the second processor. The data collected during a runtime execution of the program may include data corresponding to at least one of an execution environment, a data object involved in the execution of the program, and/or to an instruction involved in the execution of the program. In another embodiment, a provenance of the execution-based optimization profile includes an execution-based optimization profile that is usable in an execution of the program and that was created utilizing data collected during a runtime execution of the program by a second computing device (not shown) having a second processor and transparent to software executing on the second processor. In a further embodiment, a provenance of the execution-based optimization profile includes an execution-based optimization profile usable in an execution of the program and that was created by an entity that utilized data collected during a runtime execution of the program by a second processor and transparent to software executing on the second processor. The entity may include a real entity, such as a human or a person, a legal entity, such as a corporation or labor union, or a fictional entity, such as a company or partnership. In an embodiment, an entity may create the execution-based optimization profile by operating, controlling, possessing, and/or otherwise having a nexus with the creation of the execution-based optimization profile.

In an embodiment, the execution-optimization circuit 1450 of FIG. 30 includes an execution-optimization circuit operable to alter an execution of an instruction of the program by the first processor in response to the execution-based optimization profile. In another embodiment, the execution-optimization circuit includes an execution-optimization circuit operable to alter an environment of the program execution by the first processor in response to the execution-based optimization profile. In an embodiment, the execution-optimization circuit includes an execution-optimization circuit operable to alter a context of the program execution by the first processor in response to the execution-based optimization profile. In a further embodiment, the execution-optimization circuit includes an execution-optimization circuit operable to at least one of initiate, activate, cause, facilitate, accomplish, and/or achieve an alteration of an execution of the program by the first processor in response to the execution-based optimization profile. In another embodiment, the execution-optimization circuit includes an execution-optimization circuit operable to alter at least one of a memory, a data object storage schema, and/or a data object management schema corresponding to an execution of the program by the first processor in response to the execution-based optimization profile. The memory may include at least one of a cache and/or a register. In a further embodiment, the execution-optimization circuit includes an execution-optimization circuit operable to receive at least a portion the execution-based optimization profile and to alter an execution of the program by the first processor in response to the execution-based optimization profile. For example, the execution-optimization circuit may receive at least a portion the execution-based optimization profile from the information store 1430 and/or the portable information store 1440.

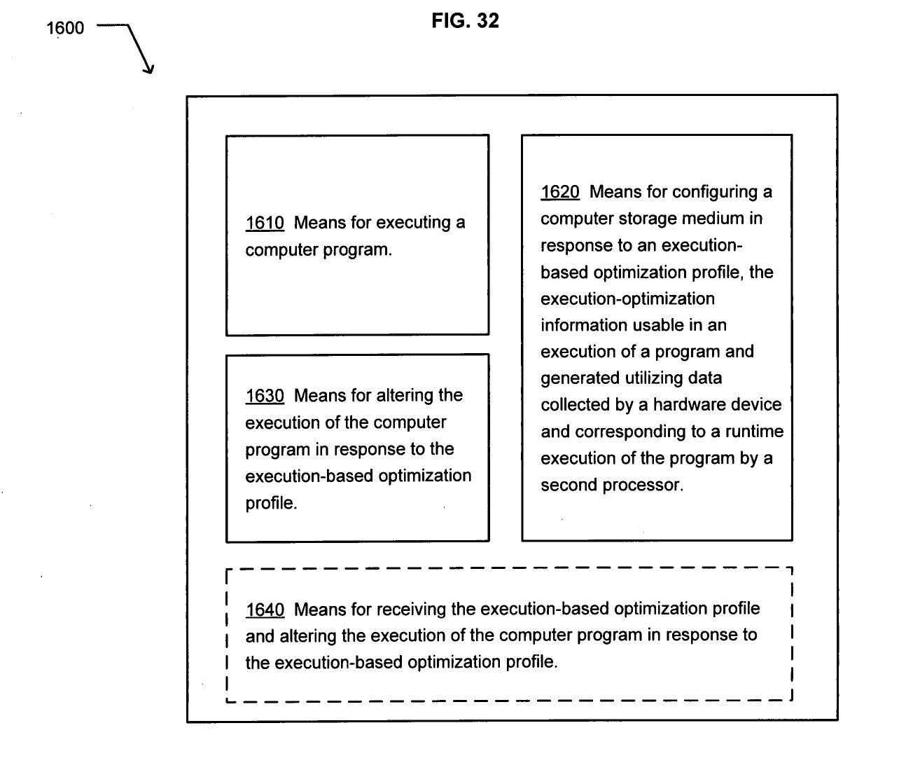

FIG. 32 illustrates a partial view of an embodiment of a device 1600 in which embodiments may be implemented. The device includes means 1610 for executing a computer program. The device also includes means 1620 for configuring a computer storage medium in response to an execution-based optimization profile. The execution-optimization information is usable in an execution of a program and was generated utilizing data collected by a hardware device and corresponding to a runtime execution of the program by a second processor. In an embodiment, the execution-optimization information was generated utilizing data collected by an evaluation entity utilizing a hardware device and corresponding to a runtime execution of the program by a second processor. The device further includes means 1630 for altering the execution of the computer program in response to the execution-based optimization profile.

In another embodiment, the device 1600 includes means 1640 for receiving the execution-based optimization profile and altering the execution of the computer program in response to the execution-based optimization profile.

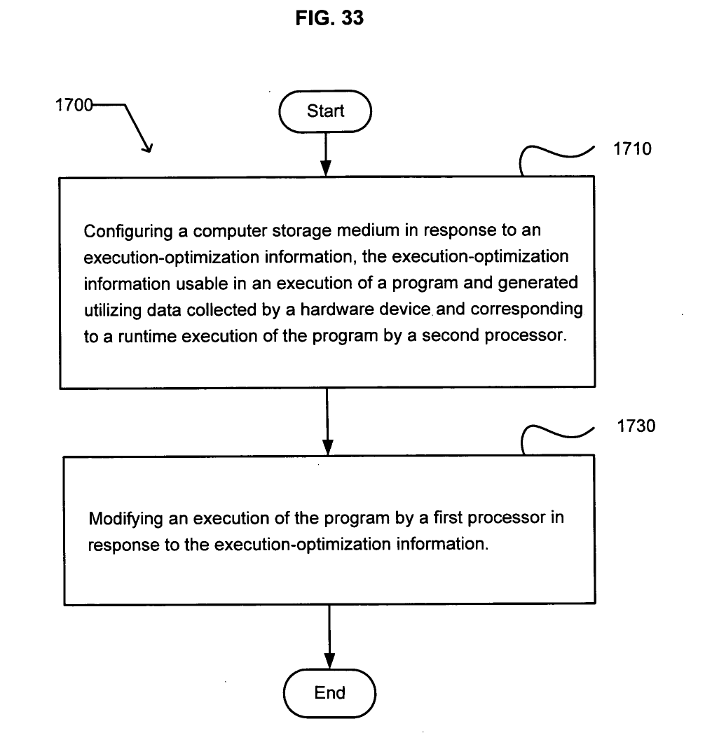

FIG. 33 illustrates an exemplary operational flow 1700. After a start operation, the operational flow moves to an arrangement operation 1710. The arrangement operation configures a computer storage medium in response to an execution-optimization information. The execution-optimization information is usable in an execution of a program and was generated utilizing data collected by a hardware device and corresponding to a runtime execution of the program by a second processor. An improvement operation 1730 modifies an execution of the program by a first processor in response to the execution-optimization information. The operational flow then moves to an end operation.

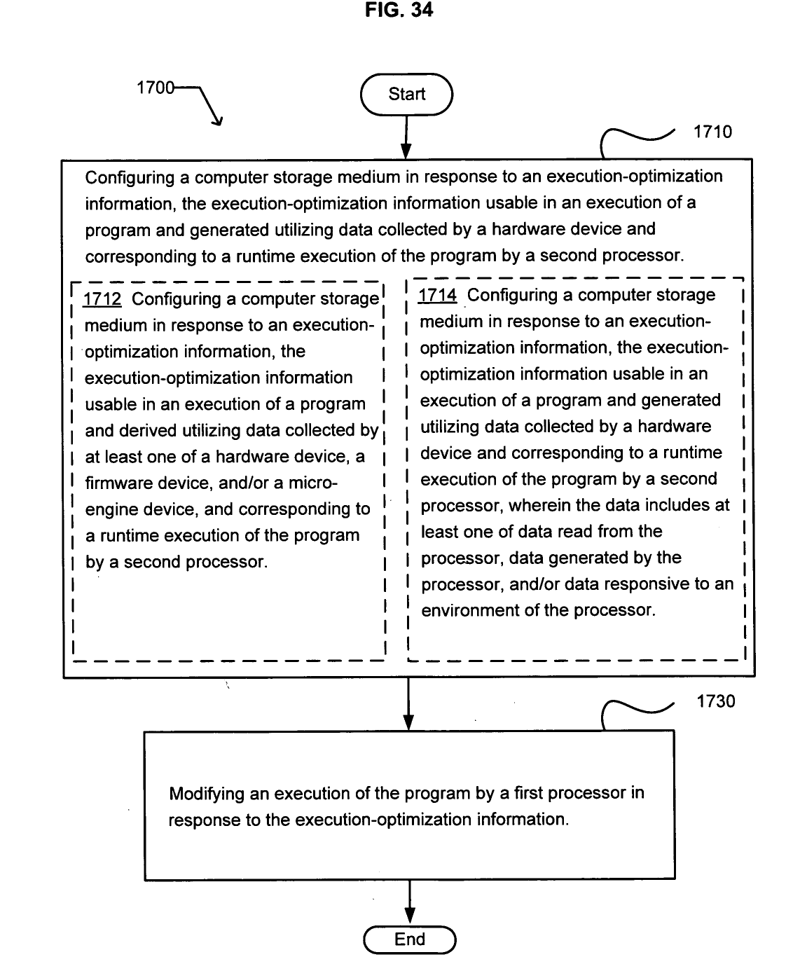

FIG. 34 illustrates an alterative embodiment of the exemplary operational flow 1700 of FIG. 33. The arrangement operation 1710 may include at least one additional operation. The at least one additional operation may include an operation 1712, and/or an operation 1714. The operation 1712 includes configuring a computer storage medium in response to an execution-optimization information. The execution-optimization information is usable in an execution of a program and was derived utilizing data collected by at least one of a hardware device, a firmware device, and/or a micro-engine device, and corresponding to a runtime execution of the program by a second processor. The operation 1714 includes configuring a computer storage medium in response to an execution-optimization information. The execution-optimization information is usable in an execution of a program and was generated utilizing data collected by a hardware device and corresponding to a runtime execution of the program by a second processor, wherein the data includes at least one of data read from the processor, data generated by the processor, and/or data responsive to an environment of the processor.

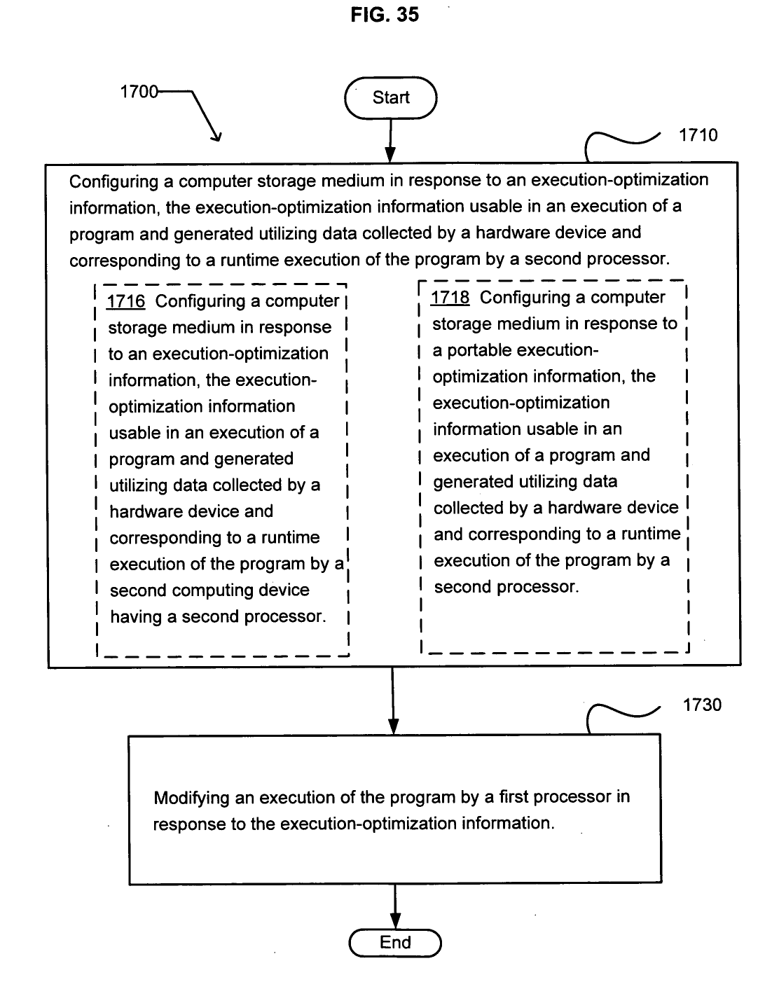

FIG. 35 illustrates another embodiment of the exemplary operational flow 1700 of FIG. 33. The arrangement operation 1710 may include at least one additional operation. The at least one additional operation may include an operation 1716, and/or an operation 1718. The operation 1716 includes configuring a computer storage medium in response to an execution-optimization information. The execution-optimization information is usable in an execution of a program and was generated utilizing data collected by a hardware device and corresponding to a runtime execution of the program by a second computing device having a second processor. The operation 1718 includes configuring a computer storage medium in response to a portable execution-optimization information. The execution-optimization information being usable in an execution of a program and generated utilizing data collected by a hardware device and corresponding to a runtime execution of the program by a second processor.

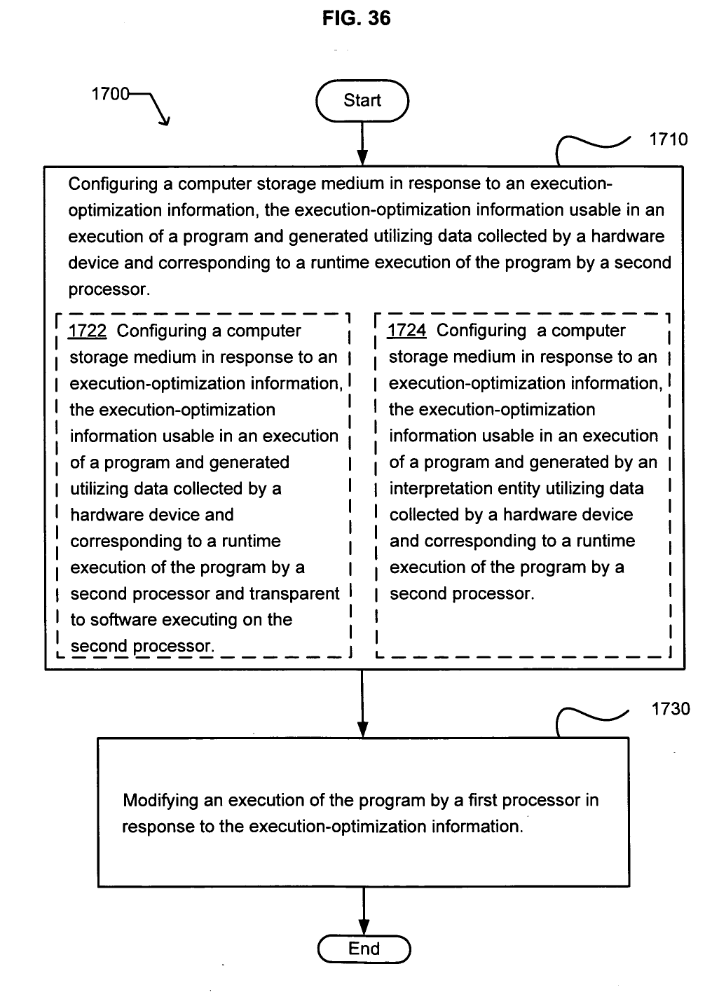

FIG. 36 illustrates a further embodiment of the exemplary operational flow 1700 of FIG. 33. The arrangement operation 1710 may include at least one additional operation. The at least one additional operation may include an operation 1722, and/or an operation 1724. The operation 1722 includes configuring a computer storage medium in response to an execution-optimization information. The execution-optimization information is usable in an execution of a program and was generated utilizing data collected by a hardware device, corresponding to a runtime execution of the program by a second processor, and transparent to software executing on the second processor. The operation 1724 includes configuring a computer storage medium in response to an execution-optimization information. The execution-optimization information being usable in an execution of a program and generated by an interpretation entity utilizing data collected by a hardware device and corresponding to a runtime execution of the program by a second processor.

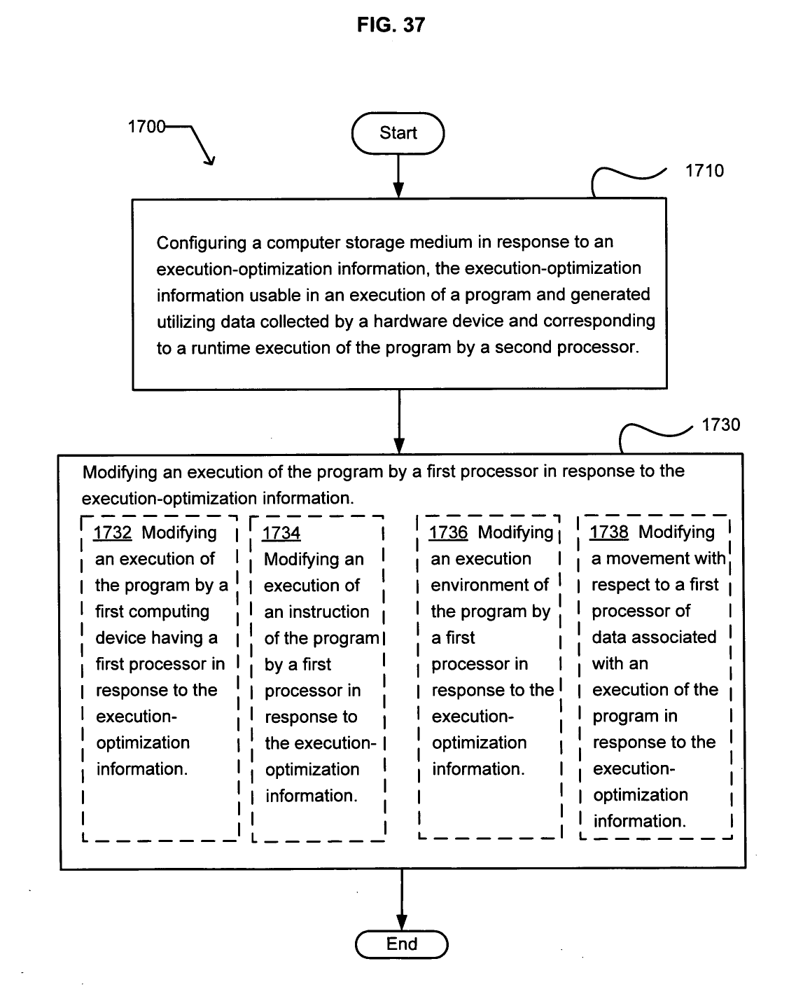

FIG. 37 illustrates another embodiment of the exemplary operational flow 1700 of FIG. 33. The improvement operation 1730 may include at least one additional operation. The at least one additional operation may include an operation 1732, an operation 1734, an operation 1736, and/or an operation 1738. The operation 1732 modifies an execution of the program by a first computing device having a first processor in response to the execution-optimization information. The operation 1734 modifies an execution of an instruction of the program by a first processor in response to the execution-optimization information. The operation 1736 modifies an execution environment of the program by a first processor in response to the execution-optimization information. The operation 1738 modifies a movement with respect to a first processor of data associated with an execution of the program in response to the execution-optimization information. In an embodiment, the movement of data may include a movement of data toward a processor or away from a processor, such as the first processor 1410 of FIG. 30. In a further embodiment, the movement of data may include a movement of data along the information store hierarchy 1500 of computer-readable media of FIG. 31. For example, in an embodiment, data may be moved directly from an instance of the outboard storage 1520 to a cache of the inboard memory 1530 without residing in system memory.

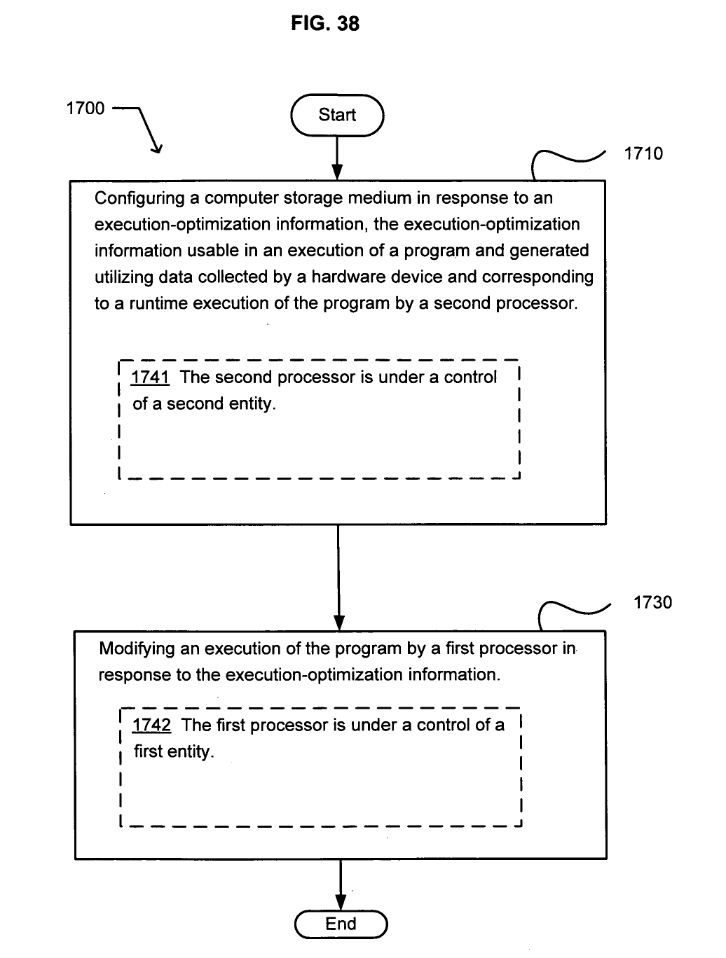

FIG. 38 illustrates a further embodiment of the exemplary operational flow 1700 of FIG. 33. In an embodiment, the second processor is under a control of a second entity 1741, and/or the first processor is under a control of a first entity 1742.

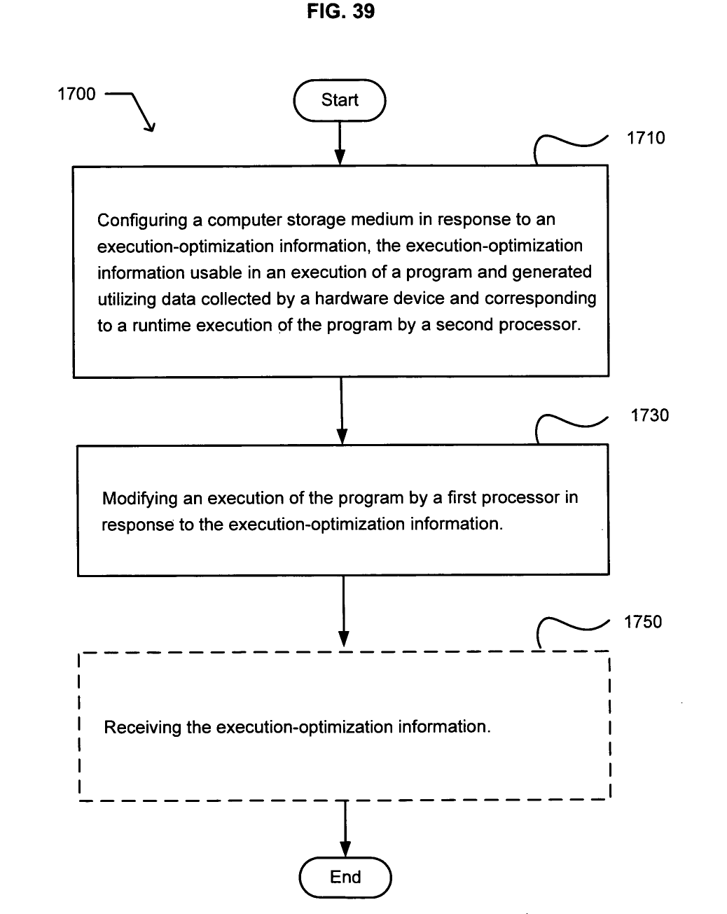

FIG. 39 illustrates another embodiment of the exemplary operational flow 1700 of FIG. 33. In an embodiment, the operational flow 1700 includes an acquisition operation 1750 that receives the execution-optimization information. For example, the receiving the execution-optimization information may include receiving the execution-optimization information 1432 from the information store 1430 as described in conjunction with FIG. 30. In another example, the receiving an execution-optimization information may include receiving the execution optimization information 1442 from the portable information store 1440 described in conjunction with FIG. 30. By way of further example, the execution-optimization information may be received over a network from a remote computing device, such from a server site over the Internet.

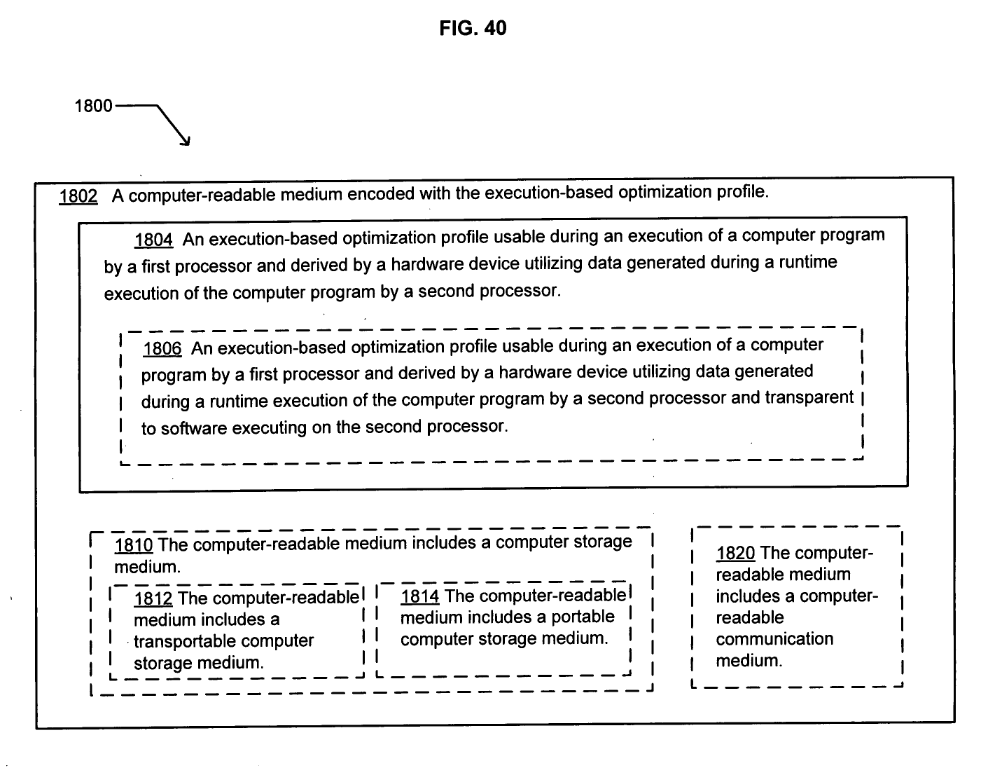

FIG. 40 illustrates an exemplary apparatus 1800 in which embodiments may be implemented. The apparatus includes a computer-readable medium 1802 encoded with an execution-based optimization profile 1804. The execution-based optimization profile includes an execution-based optimization profile usable during an execution of a computer program by a first processor and derived by a hardware device utilizing data generated during a runtime execution of the computer program by a second processor.

An alternative embodiment includes an execution-based optimization profile 1806 usable during an execution of a computer program by a first processor and derived by a hardware device utilizing data generated during a runtime execution of the computer program by a second processor and transparent to software executing on the second processor. In another embodiment, the computer-readable medium 1802 includes a computer storage medium 1810. In a further embodiment, the computer storage medium may include a transportable computer storage medium 1812, or a portable computer storage medium 1814. In an embodiment, the computer-readable medium includes a computer-readable communications medium 1820.

The foregoing detailed description has set forth various embodiments of the devices and/or processes via the use of block diagrams, flow diagrams, operation diagrams, flowcharts, illustrations, and/or examples. Insofar as such block diagrams, operation diagrams, flowcharts, illustrations, and/or examples contain one or more functions and/or operations, it will be understood by those within the art that each function and/or operation within such block diagrams, operation diagrams, flowcharts, illustrations, or examples can be implemented, individually and/or collectively, by a wide range of hardware, software, firmware, or virtually any combination thereof.

In addition, those skilled in the art will appreciate that the mechanisms of the subject matter described herein are capable of being distributed as a program product in a variety of forms, and that an illustrative embodiment of the subject matter described herein applies equally regardless of the particular type of signal-bearing media used to actually carry out the distribution. Examples of a signal-bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is defined by the appended claims.

What is claimed is:

1. An apparatus comprising:
a first processor operable to execute a program;
an information store configured by an execution-based optimization profile, the execution-based optimization profile usable in an execution of the program and that was created utilizing data collected during a runtime execution of the program by a second processor and transparent to software executing on the second processor; and
an execution-optimization circuit operable to alter an execution of the program by the first processor in response to the execution-based optimization profile.

2. The apparatus of claim 1, wherein the first processor operable to execute a program includes
a first computing device having a first processor operable to execute a program.

3. The apparatus of claim 1, wherein the information store configured by an execution-based optimization profile, the execution-based optimization profile usable in an execution of the program and that was created utilizing data collected during a runtime execution of the program by a second processor and transparent to software executing on the second processor includes
an information store configured by a portable execution-based optimization profile, the portable execution-based optimization profile usable in an execution of the program and that was created utilizing data collected during a runtime execution of the program by a second processor and transparent to software executing on the second processor.

4. The apparatus of claim 1, wherein the information store configured by an execution-based optimization profile, the execution-based optimization profile usable in an execution of the program and that was created utilizing data collected during a runtime execution of the program by a second processor and transparent to software executing on the second processor includes
an information store configured by an execution-based optimization profile, the execution-based optimization profile usable in an execution of the program and that was created utilizing data collected by a hardware device during a runtime execution of the program by a second processor and transparent to software executing on the second processor.

5. The apparatus of claim 1, wherein the information store configured by an execution-based optimization profile, the execution-based optimization profile usable in an execution of the program and that was created utilizing data collected during a runtime execution of the program by a second processor and transparent to software executing on the second processor includes
an information store configured by an execution-based optimization profile, the execution-based optimization profile usable in an execution of the program and generated utilizing data collected during a runtime execution of the program by a second processor and transparent to software executing on the second processor, the data corresponding to at least one of an execution environment, a data object involved in the execution of the program, and/or to an instruction involved in the execution of the program.

6. The apparatus of claim 1, wherein the information store configured by an execution-based optimization profile, the execution-based optimization profile usable in an execution of the program and that was created utilizing data collected during a runtime execution of the program by a second processor and transparent to software executing on the second processor includes
an information store configured by an execution-based optimization profile, the execution-based optimization profile usable in an execution of the program and that was created utilizing data collected during a runtime execution of the program by a second computing device having a second processor and transparent to software executing on the second processor.

7. The apparatus of claim 1, wherein the information store configured by an execution-based optimization profile, the execution-based optimization profile usable in an execution of the program and that was created utilizing data collected during a runtime execution of the program by a second processor and transparent to software executing on the second processor includes
an information store configured by an execution-based optimization profile, the execution-based optimization profile usable in an execution of the program and that was created by an entity utilizing data collected during a runtime execution of the program by a second processor and transparent to software executing on the second processor.

8. The apparatus of claim 1, wherein the execution-optimization circuit operable to alter an execution of the program by the first processor in response to the execution-based optimization profile includes
an execution-optimization circuit operable to alter an execution of an instruction of the program by the first processor in response to the execution-based optimization profile.

9. The apparatus of claim 1, wherein the execution-optimization circuit operable to alter an execution of the program by the first processor in response to the execution-based optimization profile includes
an execution-optimization circuit operable to alter an environment of the program execution by the first processor in response to the execution-based optimization profile.

10. The apparatus of claim 1, wherein the execution-optimization circuit operable to alter an execution of the program by the first processor in response to the execution-based optimization profile includes
an execution-optimization circuit operable to alter a context of the program execution by the first processor in response to the execution-based optimization profile.

11. The apparatus of claim 1, wherein the execution-optimization circuit operable to alter an execution of the program by the first processor in response to the execution-based optimization profile includes
an execution-optimization circuit operable to at least one of initiate, activate, cause, facilitate, accomplish, and/or achieve an alteration of an execution of the program by the first processor in response to the execution-based optimization profile.

12. The apparatus of claim 1, wherein the execution-optimization circuit operable to alter an execution of the program by the first processor in response to the execution-based optimization profile includes
an execution-optimization circuit operable to alter at least one of a memory, a data object storage schema, and/or a data object management schema corresponding to an execution of the program by the first processor in response to the execution-based optimization profile.

13. The apparatus of claim 1, wherein the execution-optimization circuit operable to alter an execution of the program by the first processor in response to the execution-based optimization profile includes
an execution-optimization circuit operable to receive at least a portion of the execution-based optimization profile and to alter an execution of the program by the first processor in response to the execution-based optimization profile.

14. A device comprising:
means for executing a computer program;
means for configuring a computer storage medium in response to an execution-based optimization profile, the execution-optimization information usable in an execution of a program and generated utilizing data collected by a hardware device and corresponding to a runtime execution of the program by a second processor; and
means for altering the execution of the computer program in response to the execution-based optimization profile.

15. The device of claim 14, wherein the means for configuring a computer storage medium in response to an execution-based optimization profile, the execution-optimization information usable in an execution of a program and generated utilizing data collected by a hardware device and corresponding to a runtime execution of the program by a second processor includes
means for configuring a computer storage medium in response to an execution-based optimization profile, the execution-optimization information usable in an execution of a program and generated by an interpretation entity utilizing data collected by a hardware device and corresponding to a runtime execution of the program by a second processor.

16. The device of claim 14, further comprising:
means for receiving the execution-based optimization profile and altering the execution of the computer program in response to the execution-based optimization profile.

17. A method comprising:
configuring a computer storage medium in response to an execution-optimization information, the execution-optimization information usable in an execution of a program and generated utilizing data collected by a hardware device and corresponding to a runtime execution of the program by a second processor; and
modifying an execution of the program by a first processor in response to the execution-optimization information.

18. The method of claim 17, wherein the configuring a computer storage medium in response to an execution-optimization information, the execution-optimization information usable in an execution of a program and generated utilizing data collected by a hardware device and corresponding to a runtime execution of the program by a second processor includes
configuring a computer storage medium in response to an execution-optimization information, the execution-optimization information usable in an execution of a program and derived utilizing data collected by at least one of a hardware device, a firmware device, and/or a micro-engine device, and corresponding to a runtime execution of the program by a second processor.

19. The method of claim 17, wherein the configuring a computer storage medium in response to an execution-optimization information, the execution-optimization information usable in an execution of a program and generated utilizing data collected by a hardware device and corresponding to a runtime execution of the program by a second processor includes
configuring a computer storage medium in response to an execution-optimization information, the execution-optimization information usable in an execution of a program and generated utilizing data collected by a hardware device and corresponding to a runtime execution of the program by a second processor, wherein the data includes at least one of data read from the processor, data generated by the processor, and/or data responsive to an environment of the processor.

20. The method of claim 17, wherein the configuring a computer storage medium in response to an execution-optimization information, the execution-optimization information usable in an execution of a program and generated utilizing data collected by a hardware device and corresponding to a runtime execution of the program by a second processor includes
configuring a computer storage medium in response to an execution-optimization information, the execution-optimization information usable in an execution of a program and generated utilizing data collected by a hardware device and corresponding to a runtime execution of the program by a second computing device having a second processor.

21. The method of claim 17, wherein the configuring a computer storage medium in response to an execution-optimization information, the execution-optimization information usable in an execution of a program and generated utilizing data collected by a hardware device and corresponding to a runtime execution of the program by a second processor includes
configuring a computer storage medium in response to a portable execution-optimization information, the execution-optimization information usable in an execution of a program and generated utilizing data collected by a hardware device and corresponding to a runtime execution of the program by a second processor.

22. The method of claim 17, wherein the configuring a computer storage medium in response to an execution-optimization information, the execution-optimization information usable in an execution of a program and generated utilizing data collected by a hardware device and corresponding to a runtime execution of the program by a second processor includes
configuring a computer storage medium in response to an execution-optimization information, the execution-optimization information usable in an execution of a program and generated utilizing data collected by a hardware device and corresponding to a runtime execution of the program by a second processor and transparent to software executing on the second processor.

23. The method of claim 17, wherein the configuring a computer storage medium in response to an execution-optimization information, the execution-optimization information usable in an execution of a program and generated utilizing data collected by a hardware device and corresponding to a runtime execution of the program by a second processor includes
configuring a computer storage medium in response to an execution-optimization information, the execution-optimization information usable in an execution of a program and generated by an interpretation entity utilizing data collected by a hardware device and corresponding to a runtime execution of the program by a second processor.

24. The method of claim 17, wherein the modifying an execution of the program by a first processor in response to the execution-optimization information includes
modifying an execution of the program by a first computing device having first processor in response to the execution-optimization information.

25. The method of claim 17, wherein the modifying an execution of the program by a first processor in response to the execution-optimization information includes
modifying an execution of an instruction of the program by a first processor in response to the execution-optimization information.

26. The method of claim 17, wherein the modifying an execution of the program by a first processor in response to the execution-optimization information includes
modifying an execution environment of the program by a first processor in response to the execution-optimization information.

27. The method of claim 17, wherein the modifying an execution of the program by a first processor in response to the execution-optimization information includes
modifying a movement with respect to a first processor of data associated with an execution of the program in response to the execution-optimization information.

28. The method of claim 17, wherein the second processor is under a control of a second entity and the first processor is under a control of a first entity.

29. The method of claim 17, further comprising:
receiving the execution-optimization information.

30. An apparatus comprising:
an execution-based optimization profile usable during an execution of a computer program by a first processor and derived by a hardware device utilizing data generated during a runtime execution of the computer program by a second processor; and
a computer-readable medium encoded with the execution-based optimization profile.

31. The apparatus of claim 30, wherein the execution-based optimization profile usable during an execution of a computer program by a first processor and derived by a hardware device utilizing data generated during a runtime execution of the computer program by a second processor includes
an execution-based optimization profile usable during an execution of a computer program by a first processor and derived by a hardware device utilizing data generated during a runtime execution of the computer program by a second processor and transparent to software executing on the second processor.

32. The apparatus of claim 30, wherein the computer-readable medium includes a computer storage medium.

33. The apparatus of claim 32, wherein the computer storage medium includes a transportable computer storage medium.

34. The apparatus of claim 32, wherein the computer storage medium includes a portable computer storage medium.

35. The apparatus of claim 30, wherein the computer-readable medium includes a computer-readable communications medium.
